(19) United States
(12) Patent Application Publication
(10) Pub. No.: US 2023/0196839 A1
(43) Pub. Date: Jun. 22, 2023

(54) THREE-DIMENSIONAL LANDMARK TRACKING IN ANIMALS

(71) Applicants: President and Fellows of Harvard College, Cambridge, MA (US); Duke University, Durham, NC (US)

(72) Inventors: Jesse Marshall, Cambridge, MA (US); Timothy William Dunn, Cambridge, MA (US); Bence Olveczky, Cambridge, MA (US); Diego Aldarondo, Cambridge, MA (US)

(73) Assignees: President and Fellows of Harvard College, Cambridge, MA (US); Duke University, Durham, NC (US)

(21) Appl. No.: 18/063,953

(22) Filed: Dec. 9, 2022

Related U.S. Application Data
(60) Provisional application No. 63/290,891, filed on Dec. 17, 2021.

(51) Int. Cl. G06V 40/20; G06V 20/40; G06V 10/82; G06T 7/73

(52) U.S. Cl. CPC G06V 40/23; G06T 7/73; G06V 10/82; G06V 20/40; G06T 2207/10016; G06T 2207/20084

(57) ABSTRACT

Systems and methods for performing long-term kinematic tracking of an animal subject are provided. Chronically-affixed motion capture markers including a tissue engaging feature and a reflective marker are described, the motion capture markers enabling long-term motion capture recording of an animal subject. A method of determining a three-dimensional pose of a subject using a trained statistical model configured to generate landmark position data associated with the three-dimensional pose of the animal subject. The method includes using projective geometry to generate three-dimensional image volumes as input to the trained statistical model. Further, a method for profiling a subject’s physical behavior over a period of time by applying clustering to information indicative of movement of the subject over the period of time is described.

### CROSS-REFERENCE TO RELATED APPLICATIONS

This application claims priority to U.S. Provisional Application No. 63/290,891, filed Dec. 17, 2021, the contents of which is incorporated herein in its entirety.

### GOVERNMENT FUNDING

This invention was made with government support under Grant No. NS 112597 awarded by the National Institutes of Health and Grant No. GM136972 awarded by the National Institutes of Health. The government has certain rights in the invention.

### FIELD

Disclosed embodiments are related to motion tracking and behavioral analysis of animals.

### BACKGROUND

The study of animal behavior is central to ethology, neuroscience, psychology, and ecology and, because animal behavior is primarily conveyed by movement, includes the study of animal movement kinematics. Animal tracking methods may include using depth cameras to track coarse measurements of an animal’s head and torso or the use of two-dimensional tracking of anatomical landmarks in confined behavioral tasks. As a result, studies of animal behavior have been typically restricted to high-resolution snapshots of individual behaviors or to qualitative descriptions of a broader range of behaviors.

### SUMMARY

In some embodiments a method for profiling a subject’s physical behavior over a period of time is provided. The method comprises: obtaining information indicative of movement of one or more portions of the subject over the period of time; clustering instances of one or more physical behaviors based at least in part on the information indicative of movement; generating a profile of the subject’s physical behavior over the period of time based on the clustered instances of the one or more physical behaviors; and outputting the profile of the subject’s physical behavior.

In some embodiments, the method further comprises applying a transform to the information indicative of movement to obtain a wavelet representation of the subject’s physical behavior over the period of time; and embedding the wavelet representation into two dimensions to obtain an embedded representation of the subject’s physical behavior over the period of time. In some embodiments, clustering instances of the one or more physical behaviors based at least in part on the information indicative of movement comprises clustering instances of the one or more physical behaviors based on the embedded representation.

In some embodiments, obtaining information indicative of movement of one or more portions of the subject comprises obtaining information indicative of movement of one or more limbs, joints, and/or a torso of the subject.

In some embodiments, obtaining the information indicative of movement comprises: obtaining a plurality of video frames, wherein video frames of the plurality of video frames recorded the subject’s physical behavior over a period of time, the video frames having been synchronously acquired by two or more cameras at different positions; and extracting, from the plurality of video frames, the information indicative of movement.

In some embodiments, the method further comprises affixing markers to the subject’s body. In some embodiments, affixing markers to the subject’s body comprises piercing the subject’s body with a marker. In some embodiments, extracting, from the plurality of video frames, the information indicative of movement comprises extracting, from the plurality of video frames, information indicative of movement of the markers affixed to the subject’s body.

In some embodiments, the method further comprises smoothing, using a filter, the information indicative of movement.

In some embodiments, generating a profile of the subject’s physical behavior comprises generating an ethogram. In some embodiments, the method further comprises identifying repeated behavioral sequences of the subject by: obtaining a similarity matrix by computing pairwise correlations using the ethogram; determining off-diagonal elements of the similarity matrix having a value over a threshold value, the off-diagonal elements corresponding to related behaviors of the subject; and clustering the related behaviors of the subject to identify repeated behavioral sequences of the subject.

In some embodiments, a method for determining a three-dimensional pose of an imaged subject is provided. The method comprises: obtaining images of the subject, the images having been simultaneously acquired by two or more cameras; generating three-dimensional spatially-aligned image volumes using the obtained images of the subject; generating, using a trained statistical model and the three-dimensional spatially-aligned image volumes, landmark position data associated with the subject; and outputting the landmark position data from the trained statistical model.

In some embodiments, generating the three-dimensional, spatially-aligned image volumes comprises: determining a three-dimensional position of the subject using triangulation and the obtained images; centering a three-dimensional grid comprising voxels around the determined three-dimensional position of the subject; projecting spatial coordinates of the voxels to two-dimensional space of the images based on known positions of the two or more cameras; and generating the three-dimensional, spatially-aligned image volumes by projecting RGB image content of the images at each two-dimensional voxel location to the voxel’s three-dimensional position.

In some embodiments, the trained statistical model comprises a neural network. In some embodiments, the neural network comprises one or more convolutional layers. In some embodiments, the one or more convolutional layers are arranged as a U-net.

In some embodiments, generating the landmark position data comprises averaging three-dimensional confidence maps generated by the trained statistical model.

In some embodiments, the method further comprises determining a three-dimensional pose of the subject using the output landmark position data.

In some embodiments, the images comprise video frames acquired synchronously by the two or more cameras over a period of time and determining the three-dimensional pose of the subject comprises determining the three-dimensional pose of the subject over the period of time.

In some embodiments, the method further comprises: obtaining, using the three-dimensional pose of the subject over the period of time, information indicative of movement of the subject over the period of time; clustering instances of one or more physical behaviors based at least in part on the information indicative of movement; generating a profile of the subject’s physical behavior over the period of time based on the clustered instances of the one or more physical behaviors; and outputting the profile of the subject’s physical behavior.

In some embodiments, the method further comprises identifying repeated behavioral sequences of the subject by: obtaining a similarity matrix by computing pairwise correlations using the profile of the subject’s physical behavior; determining off-diagonal elements of the similarity matrix having a value over a threshold value, the off-diagonal elements corresponding to related behaviors of the subject; and clustering the related behaviors of the subject to identify repeated behavioral sequences of the subject.

In some embodiments, obtaining images of the subject comprises obtaining images of an animal.

In some embodiments, a non-transitory computer readable storage medium may include instructions that when executed by one or more processors perform the method of any one of the above noted embodiments.

In some embodiments, a motion capture marker is provided. the motion capture marker comprises a tissue engaging feature and a reflective marker attached to the tissue engaging feature, the reflective marker comprising a ball lens having an index of refraction in a range from 1.25 to 3.

In some embodiments, the tissue engaging feature comprises a dermal or a transdermal piercing.

In some embodiments, the ball lens comprises a half-silvered mirror.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF DRAWINGS

The accompanying drawings are not intended to be drawn to scale. In the drawings, each identical or nearly identical component that is illustrated in various figures may be represented by a like numeral. For purposes of clarity, not every component may be labeled in every drawing. In the drawings:

FIG. 1 is a schematic of an example of an apparatus for performing motion capture of a subject, in accordance with some embodiments of the technology described herein.

FIG. 2 is a schematic of another example of an apparatus for performing motion capture of a subject, in accordance with some embodiments of the technology described herein.

FIG. 3A is a schematic of a subject having markers affixed to the subject’s body, in accordance with some embodiments of the technology described herein.

FIG. 3B shows views of a marker that can be affixed to a subject to enable motion tracking of the subject, in accordance with some embodiments of the technology described herein.

FIG. 3C shows views of a mapping of marker positions onto the skeletal structure of the subject, in accordance with some embodiments of the technology described herein.

FIG. 4 shows depictions of a rat in various poses with affixed markers and corresponding wireframe representations of three-dimensional marker positions tracked by motion capture, in accordance with some embodiments of the technology described herein.

FIG. 5A is a graph describing the number of times in which markers were removed from the body piercings of the subjects, in accordance with some embodiments of the technology described herein.

FIG. 5B is a graph describing the number of markers affixed to the subject that were detected when using different numbers of motion capture cameras to image the subject, in accordance with some embodiments of the technology described herein.

FIG. 5C is a graph describing the fraction of time markers were not tracked by the motion capture cameras, in accordance with some embodiments of the technology described herein.

FIG. 5D is a graph describing an estimated error in measured marker position, in accordance with some embodiments of the technology described herein.

FIG. 5E is a graph describing the estimated error in joint angle determined based on the error in measured marker position, in accordance with some embodiments of the technology described herein.

FIG. 6 is a schematic of a statistical model used to impute positions of affixed markers that were not tracked or were poorly tracked, in accordance with some embodiments of the technology described herein.

FIG. 7A shows exemplary marker velocities and joint angle velocities for a subject over a period of time, in accordance with some embodiments of the technology described herein.

FIG. 7B shows exemplary poses of the subject, in accordance with some embodiments of the technology described herein.

FIG. 7C shows a wavelet representation obtained based on determinations of the subject’s poses over the period of time, in accordance with some embodiments of the technology described herein.

FIG. 7D shows a two-dimensional embedded representation and a clustered two-dimensional representation of the subject’s physical behavior, in accordance with some embodiments of the technology described herein.

FIG. 7E shows an ethogram computed based on the clustered two-dimensional representation, in accordance with some embodiments of the technology described herein.

FIG. 8 shows exemplary poses selected from behavior clusters associated with rearing and stretching behaviors, in accordance with some embodiments of the technology described herein.

FIG. 9 is a flowchart illustrating a process 900 for determining a profile of a subject’s physical behavior, in accordance with some embodiments of the technology described herein.

FIG. 10 shows exemplary steps of a process for hierarchically organizing behavior to detect repeated behavioral patterns of a subject, in accordance with some embodiments of the technology described herein.

FIG. 11A shows exemplary steps of a process for determining a three-dimensional pose of an imaged subject, in accordance with some embodiments of the technology described herein.

FIG. 11B shows exemplary steps of a process for constructing a three-dimensional volume from two-dimensional images and determining a three-dimensional pose of an imaged subject, in accordance with some embodiments of the technology described herein.

FIG. 12 shows exemplary steps of a process for determining a three-dimensional pose of an imaged subject based on two-dimensional images of the subject, in accordance with some embodiments of the technology described herein.

FIG. 13 show exemplary steps of training a statistical model to determine a 3D pose of an imaged subject, in accordance with some embodiments of the technology described herein.

FIG. 14 is an exemplary architecture of a neural network trained to determine a three-dimensional pose of an imaged subject, in accordance with some embodiments of the technology described herein.

FIG. 15 is a flowchart illustrating a process 1500 of determining a three-dimensional pose of an imaged subject, in accordance with some embodiments of the technology described herein.

FIG. 16A shows exemplary three-dimensional wireframe models corresponding to a pose of an imaged subject without affixed markers, the three-dimensional wireframe models being determined using a trained statistical model, in accordance with some embodiments of the technology described herein.

FIG. 16B shows three-dimensional wireframe models corresponding to a pose of an imaged subject without affixed markers, the three-dimensional wireframe models being determined using DeepLabCut.

FIG. 16C shows a density map of behavioral space determined based on recordings of three subjects without affixed markers, in accordance with some embodiments of the technology described herein.

FIG. 16D shows the density map of FIG. 16C with overlaid behavioral clusters outlined, in accordance with some embodiments of the technology described herein.

FIG. 17 is a schematic embodiment of a system for training and/or implementing the methods disclosed herein.

### DETAILED DESCRIPTION

Identifying long-term patterns in animal behavior based on animal movement kinematics, including the three-dimensional (3D) position of an animal’s head, trunk, and/or limbs, is challenging. Determining such behavioral patterns is typically performed by manually identifying individual behaviors in recordings of a subject, which is labor intensive when attempting to identify discrete animal behaviors in long-term recordings (e.g., over hours and days). Alternatively, conventional automated methods to track the movement of an animal’s body may be used, but such conventional automated methods suffer from significant challenges. For example, depth cameras enable coarse measurements of an animal’s head and trunk but cannot track the animal’s full 3D pose and struggle with naturalistic environments due to effects of reflections. As another example, two-dimensional (2D) convolutional neural networks (CNNs) have been used for 2D tracking of anatomical landmarks in confined behavioral tasks. While their 2D predictions can be triangulated to 3D using multiple independent views, it has been difficult to use them for 3D tracking in freely moving animals, because 2D CNNs lack knowledge about the animal’s pose in 3D and do not have the ability to combine image information across views. As a result, they are not well suited to deal with occlusions and cannot readily generalize across diverse animal poses and camera perspectives. While existing methods can be powerful in constrained tasks, their 2D nature makes them less capable of quantifying natural behaviors in 3D. Accordingly, the inventors have developed improved automation for identification and classification of a recorded subject’s 3D pose and/or behavior, enabling quantitative, long-term behavioral tracking of subjects with and without motion capture markers.

The inventors have recognized and appreciated that temporary motion capture markers may not remain attached to subjects’ bodies for long periods of time and/or can alter the subjects’ natural behavior. For example, temporary markers may fall off of the subject during normal behavioral activity and/or may be removed by the subject. Accordingly, the inventors have recognized that reflective markers suitable for motion capture tracking can be chronically attached to a subject to enable motion capture tracking of the subject in some embodiments. The inventors have developed body piercing methods and devices to affix reflective markers suitable for motion capture to the subject’s body. These affixed reflective markers remain affixed to the subjects’ bodies for long durations, enabling long-term behavioral tracking through motion capture recordings.

According to some aspects, a motion capture marker includes a tissue engaging feature and a reflective marker attached to the tissue engaging feature. The tissue engaging feature may include a dermal or a transdermal piercing, in some embodiments. The reflective marker comprises a ball lens having a high index of refraction. For example, the ball lens may have an index of refraction in a range from 1.25 to 3, in some embodiments, or preferably an index of refraction of approximately 2. In some embodiments, the ball lens includes a half-silvered mirror to improve reflectivity of the marker.

In view of the above, the inventors further recognized the benefits associated with motion capture-enabled long-term behavioral tracking and have developed methods to determine a behavioral profile of subjects. The behavioral profile is determined using clustering methods and information indicative of the subjects’ movement as obtained from recordings of the subject. The clustering methods are used to characterize longer periods of time and/or larger numbers of video frames to develop full behavioral profiles of subjects over days and/or weeks. Using these long-term behavioral profiles, the inventors have further developed methods to identify stereotyped subject behaviors, behavioral sequences, and behavioral states exhibited over long-term behavioral monitoring of the subjects.

According to some aspects, a method for profiling a subject’s physical behavior includes obtaining movement information of one or more portions of the subject over a period of time. For example, movement information may be obtained by extracting the movement information from video frames that recorded the subject for the period of time. Alternatively, in some embodiments, movement information may be extracted from provided 3D poses of the subject. After obtaining the movement information, the method may include clustering instances of one or more physical behaviors based on the movement information. For example, a clustering algorithm (e.g., a watershed clustering method or any other suitable clustering method) may be used to segment the subject’s behaviors into clusters. The method also includes generating a profile of the subject’s physical behavior over the period of time based on the clustered instances of the subject’s physical behaviors. For example, an ethogram may be generated based on the clustered instances of the subject’s physical behaviors. Thereafter, the generated profile is output. For example, the generated profile may be displayed to any suitable display and/or stored in any suitable computer medium (e.g., locally and/or remotely). Additional aspects of behavioral clustering are described in “Continuous Whole-Body 3D Kinematic Recordings across the Rodent Behavioral Repertoire,” by Jesse D. Marshall, et al., published in Neuron as a Neuroresource, Vol. 109, Issue 3 on Feb. 3, 2021, which is incorporated herein by reference in its entirety.

The inventors further recognized and appreciated that the recorded motion capture data paired with clustered behavioral profiles constitutes a large data set of classified motion capture data describing the physical behavior of the recorded subjects. The inventors have recognized and appreciated that such a data set can be used to train a statistical model to determine the 3D pose of a subject. The inventors further appreciated and that such a statistical model may be extended to determine the 3D pose of a markerless subject (e.g., a subject having no reflective markers affixed to its body). The inventors accordingly developed methods for determining a 3D pose of a markerless subject using a trained statistical model.

According to some aspects, the method for determining a 3D pose of an imaged subject includes obtaining images of the subject, the obtained images having been simultaneously acquired by two or more cameras (e.g., two or more cameras at different positions relative to the subject. For example, the images may be obtained by recording the subject and/or may be obtained by retrieving the images from computer memory (e.g., local computer memory or remote computer memory). The method then includes generating 3D spatially-aligned image volumes using the obtained images of the subject. Thereafter, the method includes generating, using a trained statistical model and the 3D spatially-aligned image volumes, landmark position data associated with the subject and outputting the landmark position data from the trained statistical model. Additional aspects of behavioral clustering are described in “Geometric Deep Learning Enables 3D Kinematic Profiling across Species and Environments,” by Timothy W. Dunn, et al., published in Nature Methods, Vol. 18, on Apr. 19, 2021, which is incorporated herein by reference in its entirety.

As used herein, the term “subject” and “animal subject” may be used interchangeably. It should be appreciated that the terms “subject” and “animal subject” as used herein include any suitable animal whose motion may be tracked. For example, a subject or animal subject includes any mammalian animal such as primates, including humans, monkeys, and apes; rodents, including rats and mice; lagomorphs, including rabbits and hares; livestock, including horses, cattle, pigs, sheep, and goats; felines, including domestic cats and large cats; and/or canines, including domestic dogs, wolves, foxes, and coyotes. A subject or animal subject also includes any avian animal, including songbirds and birds of prey; reptilian animals, including lizards, turtles, and tortoises; and/or aquatic animals including fish and amphibians.

For the sake of clarity, the embodiments described herein are detailed relative to use with a rat and with specific times, frequencies, and/or other appropriate operating parameters. However, it should be understood that the various embodiments described herein may be used with any appropriate type of subject and may be configured to operate over any appropriate time period, frequency range, window time periods, as well as with or without markers depending on the particular embodiment as the disclosure is not limited to only the specific parameter ranges and combinations detailed herein.

Turning to the figures, specific non-limiting embodiments are described in further detail. It should be understood that the various systems, components, features, and methods described relative to these embodiments may be used either individually and/or in any desired combination as the disclosure is not limited to only the specific embodiments described herein.

### I. Motion Tracking of Subjects Including

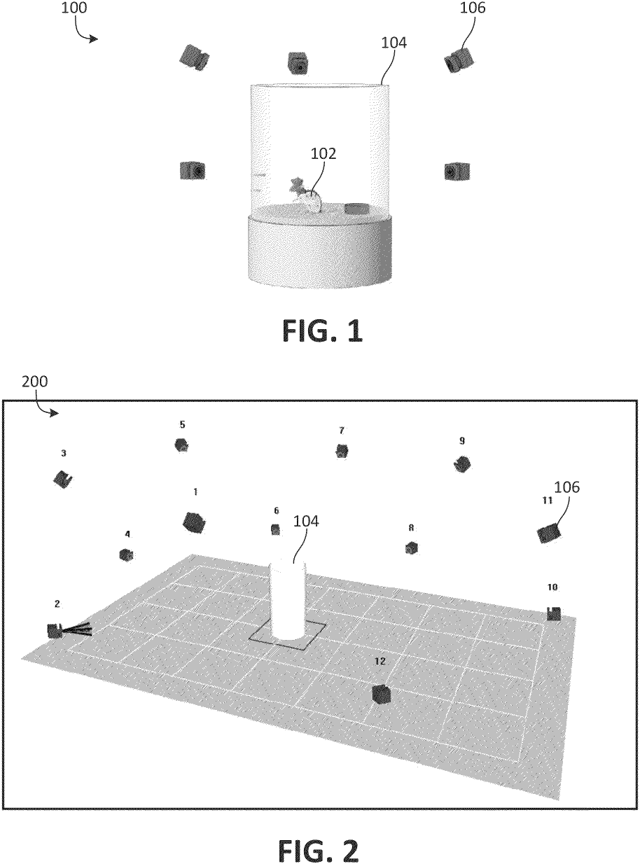

FIG. 1 is a schematic of an example of an apparatus 100 for performing motion capture recording of a subject 102, in accordance with some embodiments of the technology described herein. In motion capture, a calibrated camera array tracks the position of retroreflective markers placed on the recorded subject. The apparatus 100 includes an enclosure 104 to securely house the subject 102 and cameras 106 surrounding the enclosure 104 at known positions relative to the enclosure 104. As shown in the example of FIG. 1, the subject 102 is depicted as a rat, but it should be appreciated that any suitable animal subject may be recorded using apparatus 100.

FIG. 2 is a schematic of another example of an apparatus 200 for performing motion capture of a subject, in accordance with some embodiments of the technology described herein. The apparatus 200 includes an enclosure 104 to house the subject (not depicted) and twelve motion capture cameras 106 positioned around the enclosure 104. In some embodiments, the motion capture cameras 106 are positioned at two or more different heights around the enclosure 104 to prevent occlusion of markers affixed to the subject. In some embodiments, the motion capture cameras 106 may be positioned in a range from five to ten feet from the center of the enclosure 104. Positioning the motion capture cameras 106 at a distance from the enclosure 104 may reduce or mitigate interference caused by infrared reflections. The motion capture cameras 106 may further be oriented at 15 and/or 35 degrees relative to the horizontal, though any appropriate angle may be used.

Using apparatus 200, each subject could be tracked nearly continuously at 300 Hz for one week, though any appropriate time period or sampling frequency may be used. Unlike depth imaging approaches, the use of bedding or other objects in the enclosure 104 may not interfere with motion capture recordings, allowing the enclosure 104 to double as the subject’s home cage. Recordings from apparatus 200 showed sub-millimeter tracking precision (0.21±0.07 mm), and that segment lengths between markers affixed to the subject remained stable over the recording session, indicating that apparatus 200 could reliably report limb kinematics over one-week timespans. While tracking performance degraded slightly when using fewer cameras, there is little incentive to reduce the number of cameras. This is because, unlike with traditional video camera-based systems, adding motion capture cameras does not meaningfully add to the experimental or computational effort

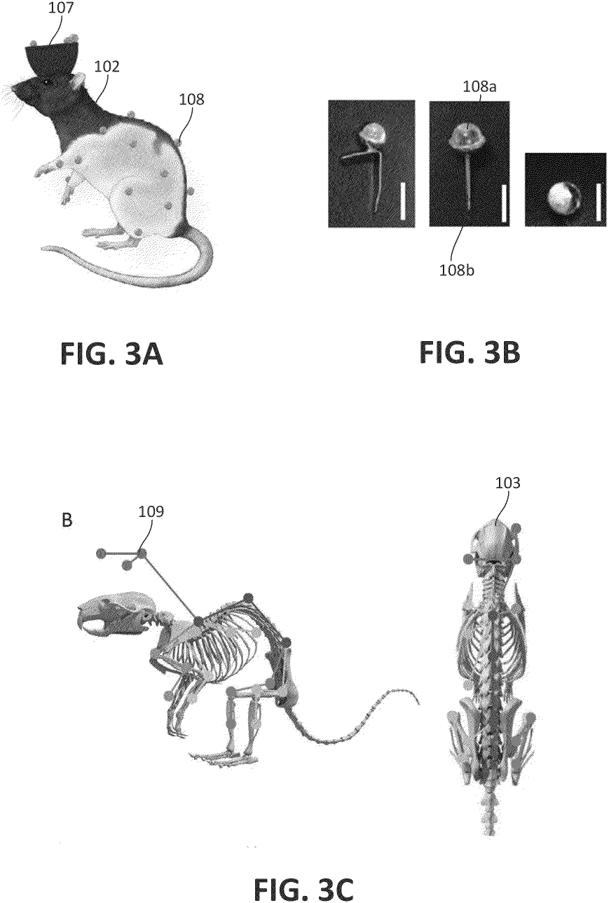

FIG. 3A is a schematic of a subject 102 with motion capture markers 108 affixed to the subject’s body, in accordance with some embodiments of the technology described herein. FIG. 3B shows views of motion capture marker 108 that can be affixed to a subject to enable motion tracking of the subject, in accordance with some embodiments of the technology described herein. FIG. 3C shows views of a mapping of marker positions 109 onto the skeletal structure 103 of the subject, in accordance with some embodiments of the technology described herein.

While well established in humans, motion capture has seen limited use in animal models due to difficulties in stably attaching markers over long recording sessions. To overcome this limitation, the inventors developed devices and methods for chronically attaching motion capture markers 108 to animal subjects using body-piercings. The motion capture markers 108 include a reflective marker 108a attached to a tissue engaging feature 108b.

In some embodiments, the reflective marker 108a includes a retroreflective ball lens formed of a material having a high index of refraction. For example, the ball lens may be formed of a material having an index of refraction in a range from 1.25 to 3, or may be formed of a material having an index of refraction of about 2, in some embodiments. Additionally, the reflectivity of the reflective marker 108a may be increased by including a half-silvered mirror on the ball lens. The ball lens may be of any suitable size relative to the subject 102. In the example depicted by FIG. 3A, where the subject is a rat, the ball lens may have a diameter in a range from 4 to 6 mm.

In some embodiments, the tissue engaging feature 108b includes a dermal piercing such as a transdermal or microdermal piercing with a shaft, or other portion, that is configured to be embedded and retained in the dermis of a subject. The reflective marker 108a may be attached to a shaft, or other portion, of the dermal piercing exposed at a surface of the subject’s dermis. For example, epoxy, threading, or any other appropriate type of fastening method may be used to attach the reflective marker 108a to the tissue engaging feature 108b. Depending on the specific type of piercing, the marker may either be attached to the piercing either prior to and/or after the piercing has been applied to the subject.

To affix the motion capture markers 108 to the subject 102, standard body piercing techniques may be employed, in some embodiments. For example, to attach markers to the spine, trunk and hips of a rat subject, two small incisions may be made, spaced apart by 1 cm, and a sterile, beveled, 18-gauge needle may be drawn through the incisions to draw open the piercing sites. The tissue engaging features 108b may then be inserted through the ends of the incision and secured in place. Incisions and piercings may be oriented perpendicularly to the skin lines of maximal tension. As another example, for markers on the shoulders, forelimbs and hindlimbs, a sterile, 18 gauge hollow needle may be inserted through two points on the skin spaced 10 mm apart. Then, an end of the tissue engaging features 108b may be inserted through the hollow end of the needle, thereafter retracting the needle from the skin. To then secure limb piercings, earnuts may be attached to the bac of the tissue engaging features 108b. The earnuts may be spaced from the skin (e.g., using damp wooden barriers) and soldered to the tissue engaging features 108b using a soldering iron and solder flux.

In some embodiments, motion capture markers 108 may be placed based on the skeletal structure 103 of the subject 102. For example, the motion capture markers 108 may be positioned to track the major joint angles of the head, trunk, forelimbs and hindlimbs of the subject as indicated by marker positions 109 in the example of FIG. 3C. Additionally, in some embodiments, two markers may be placed asymmetrically on the trunk. This asymmetry may allow the motion capture body model to distinguish between the left and right sides of the subject.

In some embodiments, motion capture markers 108 may further be placed on a headcap 107 to enable tracking of the position and angular rotations of the subject’s head. For example, three motion capture markers 108 may be attached to the headcap 107. The motion capture markers 108 attached to the headcap 107 may be positioned in an isosceles triangle to improve marker distinction based on pairwise distances.

As an example, for a rat subject as shown in FIGS. 3A-3C, approximately 20 motion capture markers 108 may be used to track the motion of the subject. Three markers along the animal’s spine at the sixth thoracic vertebrae (Th6), the first lumbar vertebrae (L1) and the first sacral vertebrae (S1). To provide asymmetry for distinguishing the left and right sides of the animal, two markers may be placed on the animal’s left trunk, midway along the anterior-posterior axis between each pair of adjacent spine markers and located 20 mm vertically beneath the spine. Markers over the animal’s hips may be placed along the femur above the trochanter minor. Ten markers may be used to track the position and configuration of the forelimbs and hindlimbs. Three markers may be attached to each forelimb: one over the scapula, 10 mm from the posterior endpoint, one over the olecranon (elbow), and one at the midpoint of the ulna. Two markers may be attached to each hindlimb: one on the animal’s patella and one at the midpoint of the tibia. Of course while specific positions on a rat are detailed above, it should be understood that other locations for the markers and uses with other animals are also contemplated.

To test whether body piercings altered the animal subject’s behavioral repertoire, a headcap was fitted with retroreflectors to n = 3 rats and tracked for two days before piercings were attached. Animal subjects with and without body piercings showed equal fractions of time spent moving in the arena and similar distributions and covariances of head velocities. A classifier trained to identify the animal’s behavior from the tracked movements of the headcap predicted equivalent behavioral usage before and after marker attachment, altogether suggesting that piercings do not cause major behavioral changes in animal subjects.

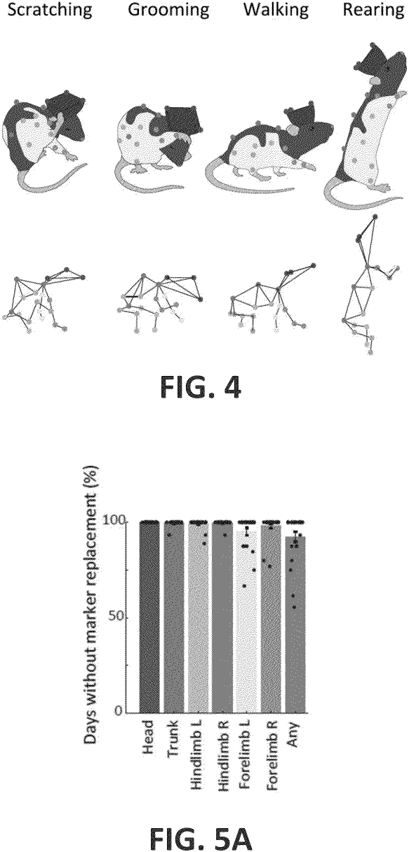

FIG. 4 shows depictions of a rat in various poses with affixed markers (top) and corresponding wireframe representations of three-dimensional marker positions tracked by motion capture (bottom), in accordance with some embodiments of the technology described herein. The marker positions are colored by the major body segments that were tracked. The rat is shown engaging in different species-typical behaviors including scratching, grooming, walking, and rearing on its hind limbs.

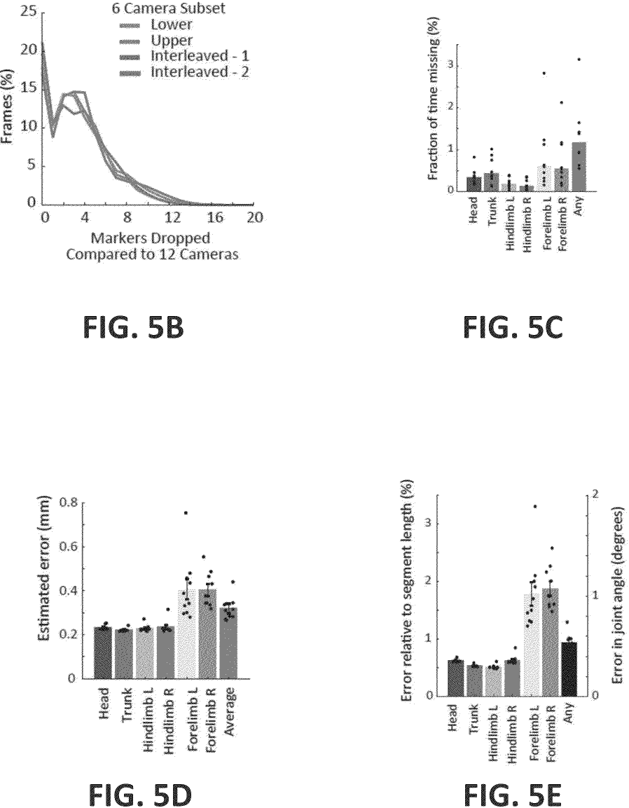

FIG. 5A is a graph describing the number of times in which motion capture markers 108 were removed from the body piercings of the subjects, in accordance with some embodiments of the technology described herein. The data of FIG. 5A was acquired across n = 23 animals and 264 days and describes the number of times in which motion capture markers 108 required replacement due to removal of the retroreflective marker from the body piercings. The body piercings themselves were never removed. The motion capture markers 108 were reattached on less than 8% of days, an effect largely driven by removal of forelimb markers. Data points from individual rat subjects are shown in black. Error bars reflect mean ± the standard error of the mean (SEM) across rat subjects.

FIG. 5B is a graph describing the number of markers affixed to the subject that were detected when using 6 or 12 motion capture cameras to image the subject, in accordance with some embodiments of the technology described herein. The data of FIG. 5B was acquired across n = 5 animals over 2.7 • 10⁶ frames in which animals were moving in the frames. Comparisons were made for four different subsets of motion capture cameras: the lower and upper sets of cameras, and two different subsets of alternating camera pairs. The shaded error bars denote the mean ± the standard deviation (SD) following 100 bootstrapped samples.

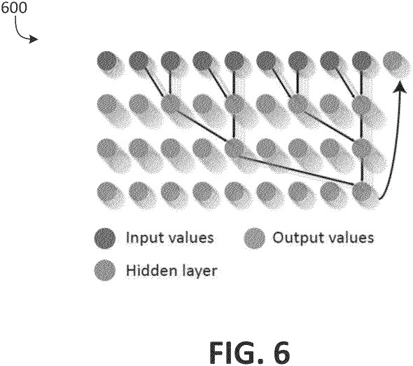

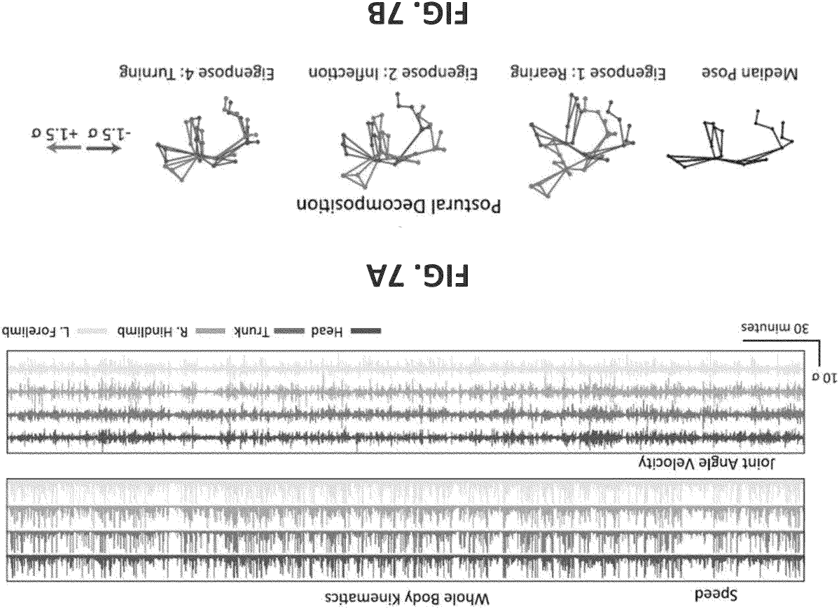

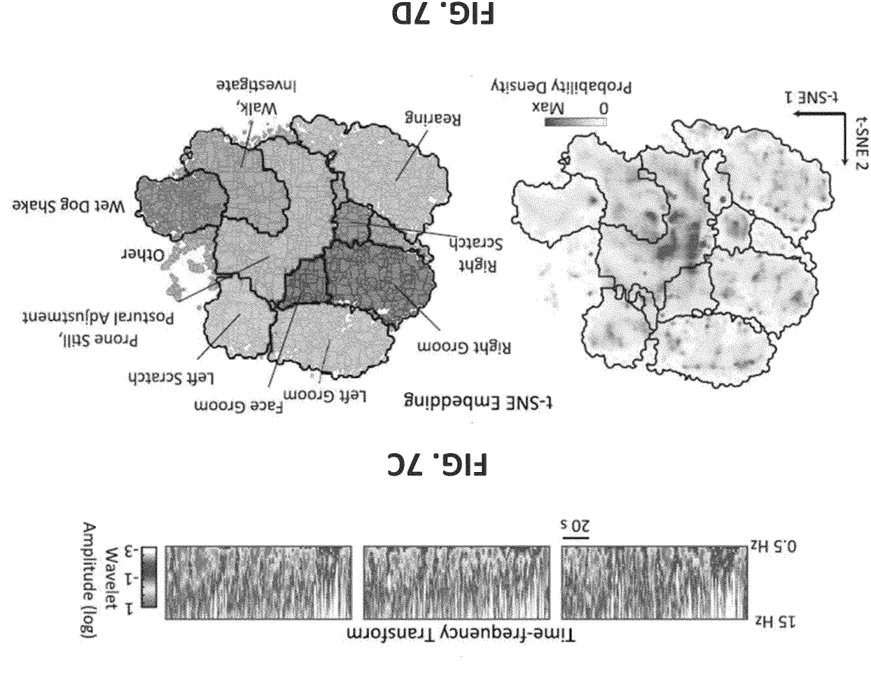

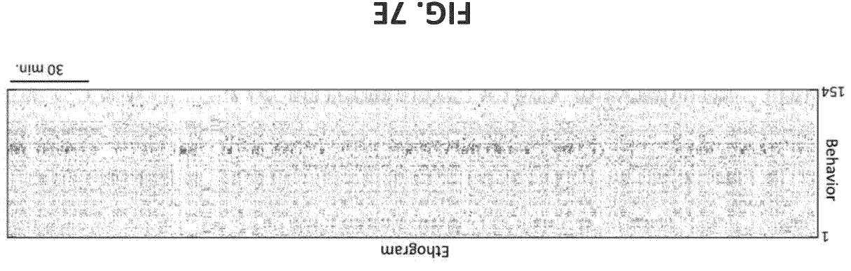

FIG. 5C is a graph describing the fraction of time markers were not tracked by the motion capture cameras, in accordance with some embodiments of the technology described herein. Following imputation using a temporal convolutional network, as described in connection with FIG. 6 herein, all markers were tracked for -99% of times in which animal subjects were moving.

FIG. 5D is a graph describing an estimated error in measured marker position, in accordance with some embodiments of the technology described herein. To determine the estimated error in measured marker position, the estimated imputation error and reprojection error were combined to yield the overall estimated error in measured marker position. The estimated error in measured marker position demonstrates sub-mm average precision in motion capture marker tracking. Data points from individual rats are shown in black, and error bars reflect the mean ± SEM across days.

FIG. 5E is a graph describing the estimated error in joint angle determine based on the error in measured marker position, in accordance with some embodiments of the technology described herein. The ratio between the estimated error in marker position and the average segment length the marker defines the estimated error in joint angle in the limit of small deviations. Estimates in FIGS. 5D and 5E are derived from 8.8 • 10⁷ frames from n = 10 full days of recording across 5 animals.

Like all vision-based tracking approaches, unprocessed motion capture recordings may be prone to dropouts of forelimb and hindlimb markers due to self- or environmental-occlusion. The vast majority of these dropouts were brief (~20 ms in duration), allowing the use of standard interpolation methods based on the temporal history of marker position to faithfully reconstruct the position of dropped markers. However, as these methods do not incorporate constraints from neighboring markers or model long-timescale influences on marker position, they perform poorly for longer dropouts.

To address this, the inventors developed a trained statistical model and trained the statistical model using a large collection of well-tracked motion capture data (~25 million frames per day). FIG. 6 is a schematic of a trained statistical model 600 used to impute positions of affixed markers that were not tracked or were poorly tracked, in accordance with some embodiments of the technology described herein. In some embodiments, the trained statistical model 600 may be a temporal convolutional network configured to predict a given marker’s position using both temporal information about its past locations, as well as spatial information about the position of all other markers. For example, for each timepoint to be imputed, the egocentric marker positions from the previous 9 frames, sampled at 60 Hz, were used as inputs to the network. These inputs were passed through three layers of dilated convolutions with 512 filters per layer to obtain predictions for the following frame for each marker. Neurons in the network used a linear activation function. Networks using a rectified-linear activation performed similarly. The implementation of trained statistical model 600 resulted in a low, ~1 mm estimated median error during artificial dropout periods. Following imputation, all 20 markers were well tracked for -99% of frames when animals were active, resulting in a sub-millimeter positional error across markers.

The inventors further compared the 3D tracking accuracy of the motion capture tracking techniques described herein in contrast with DeepLabCut, a 2D convolutional neural network for pose estimation. Using a first approach of fine-tuning a pretrained DeepLabCut network using a small number (225) of hand-labeled frames of data to detect keypoints in frames from 6 synchronized, calibrated cameras, which were then triangulated across cameras to produce estimates of the animal’s 3D posture. Inspection revealed the keypoint predictions by DeepLabCut to be poor, showing substantial deviation from human keypoint labels on a held-out test dataset. These predictions were worse on the appendages or when using predictions from 3 cameras, indicating that DeepLabCut struggled to track occluded markers.

To test whether DeepLabCut would perform better with more training data, the inventors trained DeepLabCut using 100-100,000 frames that were labeled by projecting ground truth marker positions determined by motion capture into video frames. DeepLabCut Networks trained on large numbers of samples (10,000 and 100,000), showed accurate tracking for in-sample frames, even on frequently occluded keypoints on the forelimbs and hindlimbs. This performance degraded substantially for those DeepLabCut networks trained on fewer numbers of frames (100 and 1000), especially when using only 3 cameras.

However, even when trained on a large number of samples, these 2D convolutional networks did not generalize to tracking out-of-sample video frames of rats bearing markers. DeepLabCut networks applied to out-of-sample video frames showed 20-30 mm average tracking error, making it impossible to accurately reconstruct the animal subject’s posture on the vast majority of frames. Estimating performance with 6 additional cameras (12 total) did not rescue performance on these out-of-sample video frames, consistent with past reports suggesting dozens of cameras and tens to hundreds of thousands of domain- and view-specific hand labels are required for 3D tracking using 2D convolutional networks. Lastly, training DeepLabCut using large numbers of labeled frames and then fine-tuning the network again on hand-labeled frames from an out-of-sample recording of a markerless rat did not substantially improve tracking. Thus, while useful for tracking in constrained behavioral tasks, 2D convolutional networks are not currently well suited to the more general problem of 3D tracking across multiple naturalistic behaviors in freely moving animals.

### II. Behavioral Analysis Using Clustering

Having established systems and methods for precise motion capture tracking over long timescales, the inventors next developed methods for identifying the frequency and transition structure of animal subject behaviors based on kinematic recordings obtained from motion capture tracking. FIG. 7A shows exemplary motion capture marker velocities (top) and joint angle velocities (bottom) obtained from recordings of a subject over a period of time, in accordance with some embodiments of the technology described herein.

To identify behaviors in motion capture recordings, the inventors first defined a set of 140 per-frame features describing the pose and kinematics of rats within an approximately 500 ms local window of recording. Many of these features were obtained by computing eigenpostures of the animal subjects from the measured kinematics, an example of which are shown in FIG. 7B. These eigenpostures included commonly-observed postural changes such as rearing or turning to the left and right.

In some embodiments, the 140 features include two sets of features: (1) a set of 80 features specifically selected to provide information about 37 pairs of behavioral distinctions commonly recognized by rodent researchers, such as rearing, walking, and the subphases of facial and body grooming, and (2) a more general set of descriptors to enable discrimination between kinematic variants of these behaviors. To select the features most informative about behavioral distinctions, a set of 985 features describing the pose kinematics of the animal subject in a 500 ms window was first generated, though other time windows may also be used. This 985-feature set included both per-marker features describing the velocity of individual markers on different timescales, and whole-organism features, which conveyed information about the relative position and velocity of markers as a group. Per-marker features included the cartesian velocity components of each marker in the animal’s egocentric reference frame, smoothed on 100, 300, and 1000 ms time intervals, as well as the moving standard deviation of each velocity components within each interval. Additionally, features encapsulating the animal’s overall speed were included, such as: the average velocity and standard deviation of the animal in the world reference frame in each time interval. To compute whole-organism features, information across the 10 markers on the top of the animal, which included the head, trunk, and hips, was combined. The top 10 principal components of this marker set’s Cartesian position, segment lengths and selected joint angles were calculated over time. To additionally compute features with frequency-specific information, a wavelet transform of each of these pose features using 25 mortlet wavelets spaced between 0.5 and 60 Hz was computed. This yielded a set of 250 time-frequency coefficients that were compressed by computing the top 15 principal components of the wavelets. In all cases in which the principal components of a set of pose or wavelet features were computed, the top eigenvectors from one animal subject were used as a fixed basis set to compute the top principal components of each of these feature categories across all animal subjects.

Features were then selected that provided information about behavioral distinctions. Two observers used a custom graphical user interface to annotate a subset of 1.56 • 10⁴ motion capture frames with one of 37 commonly recognized rodent behaviors across n = 3 animals. The information each feature provided about pairs of behavioral distinctions was computed. 80 features were selected, chosen by the presence of an approximate knee in the cumulative pairwise discriminability, that were most informative about behavioral distinctions: the top 10 and 6 principal components, respectively, of the Euclidean pose and segment lengths, the top 10, 15, and 15 principal components, respectively, of the wavelet transform of the joint angles of both the whole animal and, separately, the head and trunk, the relative speed of the head, hips, and trunk within a 100 and 300 ms window, the absolute speed of the trunk and its standard deviation in a 100 and 300 ms window, and the z-component of the trunk and head velocity averaged over a 100 and 300 ms window.

To provide greater ability to distinguish between new behaviors and kinematic variants of behavior not previously recognized by rodent researchers, a set of more general features was computed that describe the configuration and kinematics of all 20 motion capture markers. A tree of links between markers was generated that approximated the major joint angles of the head, neck, trunk, forelimbs and hindlimbs, and computed the segment lengths, joint angles, and Cartesian pose of these links. The top ten principal components of each of these feature categories was computed. To provide a set of kinematic descriptors of each frame, the wavelet transform of each of these ten principal components was also computed, using the same wavelet parameters as above. All principal components were computed using a common set of eigenvectors computed from one animal subject. Concatenating these postural and kinematic descriptors produced a 60-dimensional feature set that was combined with the features selected above to yield a 140-dimensional feature vector for each frame, which was then whitened.

This 140-dimensional feature set was sufficient for separating and commonly recognized behaviors and their kinematic variants. Some of these features, such as the principal components of the Cartesian and joint angle eigenpostures contain redundant information suggesting a more parsimonious feature space may be used. Conversely, some behaviors, such as sniffing, that are subtle or difficult to hand-annotate may not be emphasized in the feature selection approach above. Other feature engineering approaches, guided by ground truth datasets, could be used to weight, select, or expand this to facilitate interpretable behavioral embedding and classification.

In some embodiments, after determining the 140-dimensional feature set, a time-frequency transform may be computed to obtain a wavelet representation. FIG. 7C shows an exemplary wavelet representation obtained based on determinations of the subject’s poses over the period of time depicted in FIG. 7A. The wavelet representation is a time-frequency decomposition of the eigenposture scores over time and may be computed using a wavelet transform.

In some embodiments, to identify repeated instances of behaviors, the wavelet representation may then be embedded into two-dimensions to create an embedded representation that facilitates clustering and exploratory data analysis. FIG. 7D shows, at left, and example of a two-dimensional embedded representation including probability densities related to a probability of behavioral expression, in accordance with some embodiments of the technology described herein. The embedded representation may be embedded into two-dimensions using, for example, t-distributed stochastic neighbor embedding (t-SNE). The resulting embedded representation contains density peaks that corresponded to repeated instances of similar behaviors.

To create a co-embedding across multiple animal subjects, the feature matrix of frames in which animal subjects were moving may be concatenated. For example, the feature matrix for 16 rats across 73 different behavioral conditions was concatenated (including 1.04 • 10⁹ frames). This concatenated feature matrix was sampled at 1 Hz to create a feature vector comprising approximately 10⁶ timepoints. Because t-SNE uses an adaptive similarity metric between points, when embeddings were created by uniformly sampling the data, the embeddings were dominated by large regions when the animal was relatively still or adjusting its posture. The feature set was therefore balanced by performing k-means clustering on the full 10⁶ frame feature matrix using 8 clusters. 30,000 samples were drawn from each cluster to create a 240,000 frame feature matrix that was embedded using a multi-core implementation of t-SNE. Adding further samples was found to overcrowd the t-SNE space. In some embodiments, t-SNE embedding may be performed using the Barnes-Hut approximation with θ = 0.5 and the top 50 principal components of the feature matrix. For co-embeddings across multiple animal subjects, a perplexity of 200 may be used. After creation of the embedding space, out-of-sample points may be re-embedded in two steps. First, the 25 nearest neighbors to the out-of-sample point may be determined in the 140-dimensional feature space of whitened features. Next, the position of the first nearest neighbor may be determined in the embedding space.

After embedding, the embedded representation may then be clustered to determine a behavioral map, in some embodiments. FIG. 7D shows, at right, a clustered representation of subjects’ physical behavior obtained from the embedded representation shown at left in FIG. 7D, in accordance with some embodiments of the technology described herein. The embedded representation may be clustered using, for example, a watershed transform. To create behavioral clusters, the embedded representation may additionally be smoothed prior to clustering, in some embodiments. For example, the embedded representation may be smoothed with a gaussian kernel of width 0.125, ~2 times the width of the spatial autocorrelation of the t-SNE map.

After clustering, two observers defined the kinematic criteria for assigning behavioral clusters into one of 12 coarse behavioral categories, such as walking, rearing, or grooming. The observers also established criteria for further assigning clusters to one of ~80 fine behavioral categories, such as ‘low rear’, ‘high rear’, and ‘right head scratch’, that provided additional detail regarding the exact posture and kinematics of the animal. Each observer then watched 24 instances of each behavior selected at random from one animal and assigned each behavioral cluster into a coarse and fine behavioral category. Coarse behavioral boundaries drawn on the behavioral maps are hand drawn approximations to the occurrence of coarse behavioral labels in the dataset.

Using the clustered behavioral maps, a profile of the subjects’ behavior may be generated. For example, an ethogram may be computed to describe behavioral usage over time. FIG. 7E shows an ethogram computed based on the behavioral map of FIG. 7D, in accordance with some embodiments of the technology described herein.

The methods described herein thus offer the ability to comprehensively profile the kinematics of a subject’s behavioral repertoire. As a demonstration of this, the frequency spectrum of different body parts during rhythmic behaviors was examined, specifically grooming, scratching, and wet dog shakes. Grooming of the body consistently showed peaks in the frequency of the head and side-specific forelimb speed at 4 Hz and 7-9 Hz, consistent with past reports. In contrast, scratching showed side-specific frequency peaks across a 7-12 Hz range, consistent with the 15-20 Hz frequency reported in mice when adjusted for body size. Wet dog shakes showed a peak in trunk power at 14 ± 0.6 Hz, consistent with past work using high-speed video analysis. Interestingly, while instances of wet dog shakes and grooming showed similar behavioral frequency, but variable amplitude, scratching behaviors varied more broadly in both their frequency and amplitude, suggesting that they may be generated by more flexible or less robust control circuits.

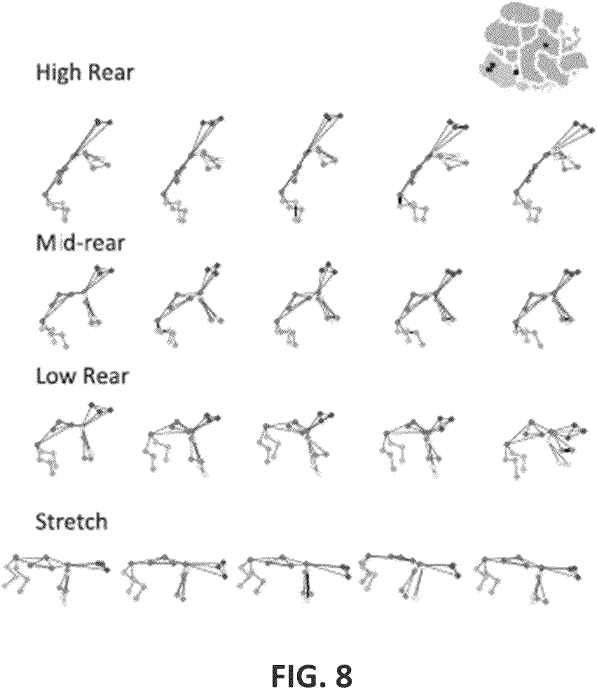

Furthermore, the methods described herein enabled the detection of variability in non-rhythmic behaviors, for instance postural variability in static rearing behaviors. FIG. 8 shows exemplary poses selected from non-rhythmic behavior clusters associated with rearing and stretching behaviors, in accordance with some embodiments of the technology described herein.

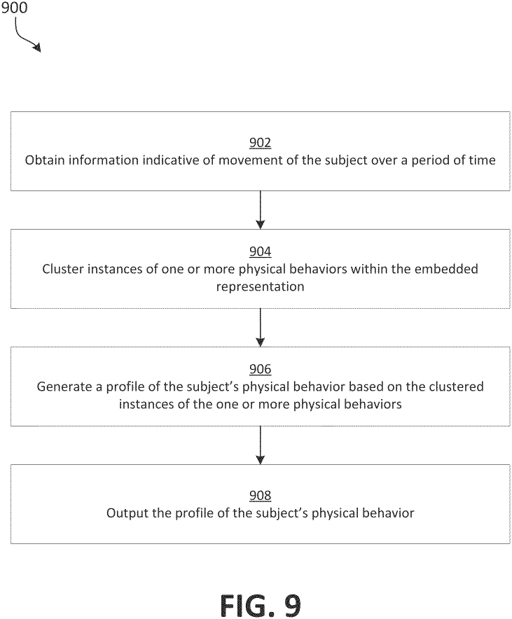

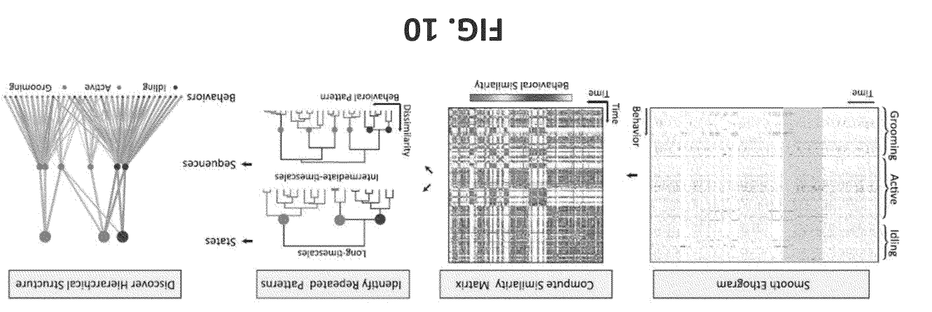

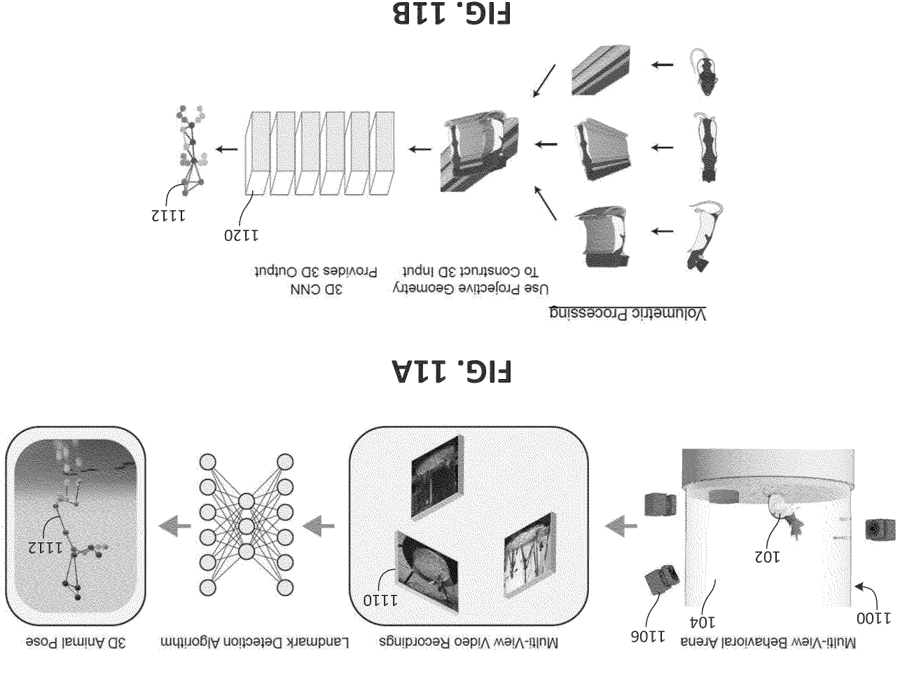

FIG. 9 is a flowchart illustrating a process 900 for determining a profile of a subject’s physical behavior, in accordance with some embodiments of the technology described herein. Process 900 may be executed using any suitable computing device (e.g., computing device 1700 as described herein). For example, in some embodiments, process 900 may be performed by a computing device co-located (e.g., in the same room) with a motion capture apparatus (e.g., apparatuses 100 and/or 200) that obtained the information indicative of motion by recording a subject. As another example, in some embodiments, process 900 may be performed by one or more processors located remotely from the motion capture apparatus (e.g., as part of a cloud computing environment, as part of a remote network) that obtained the information indicative of motion by recording the subject.

Process 900 begins at act 902, where information indicative of movement of the subject over a period of time is obtained. In some embodiments, obtaining information indicative of movement of one or more portions of the subject comprises obtaining information indicative of movement of one or more limbs, joints, and/or a torso of the subject. In some embodiments, the information indicative of movement had been previously obtained by a motion capture apparatus and stored for subsequent analysis, so that it is accessed at act 902. In other embodiments, the information indicative of movement may be obtained by a motion capture apparatus (including any motion capture apparatus described herein) as part of process 900.

In some embodiments, obtaining the information indicative of movement may include obtaining a plurality of video frames (e.g., by accessing or recording said video frames). The obtained video frames may have recorded the subject’s physical behavior over a period of time. In some embodiments, the video frames may have been synchronously acquired by two or more cameras located at different positions relative to the subject. For example, the video frames may have been synchronously acquired by 6 to 12 cameras located at different positions relative to the subject.

In some embodiments, the information indicative of movement may be extracted, from the plurality of video frames. For example, the information indicative of movement may be extracted using motion capture techniques to determine kinematic information related to positions on the subject’s body. In some embodiments, markers may be affixed to the subject’s body to enable motion capture tracking of the subject. Affixing markers to the subject’s body may be performed by piercing the subject’s body with a motion capture marker such that, in some embodiments, extracting, from the plurality of video frames, the information indicative of movement comprises extracting, from the plurality of video frames, information indicative of movement of the markers affixed to the subject’s body. However, other types of markers may also be used.

After act 902, the process may proceed to act 904, where instances of one or more physical behaviors may be clustered together within an embedded representation of the subject’s physical behaviors. In some embodiments, the method further includes smoothing, using a filter, the information indicative of movement prior to clustering the embedded representation. For example, a gaussian filter may be used to smooth the information prior to clustering.

In some embodiments, prior to clustering, the embedded representation may be generated by applying a transform to the information indicative of movement to obtain a wavelet representation of the subject’s physical behavior. Then, the wavelet representation may be embedded into two dimensions to obtain the embedded representation of the subject’s physical behavior. For example, the wavelet representation may be embedded using t-SNE clustering techniques to obtain the embedded representation.

After act 904, the process 900 may proceed to act 906. In act 906, a profile of the subject’s physical behavior may be generated based on the clustered instances of the one or more physical behaviors. For example, generating the profile of the subject’s physical behavior may include generating an ethogram that describes the subject’s behavior over time.

After act 906 completes, the process 900 may proceed to act 908, where the profile of the subject’s physical behavior may be output. For example, the profile may be saved on computer memory for subsequent access, transmitted to a recipient over a network, displayed to a person, and/or printed as a hard copy.

The inventors have further developed methods to detect repeated behavioral patterns of a subject or subjects. Animal behavior is thought to be hierarchically structured in time into repeated behavioral patterns, yet systematic, quantitative means of identifying these structures have been lacking. To address this, the inventors investigated whether there is a longer-timescale temporal structure in rodent behavior by examining the behavioral transition matrix at different timescales. The inventors found significantly more structure in the transition matrix at 10-100 second timescales than predicted by a first-order Markov chain, a time-invariant process that is commonly used to model behavioral dynamics.

To elucidate the nature of these non-Markovian behavioral structures, the inventors developed a method to identify temporal epochs with similar patterns of behavioral usage on a fixed timescale, τ. As examples of these patterns, 15-s and 2-min timescales were used, which identified distinct behavioral patterns. On 15-s timescales, the method identified sequentially ordered patterns in the behavior, such as ‘canonical’ grooming sequences of the face followed by the body or the performance of stereotyped lever-pressing sequences acquired during training. These detected patterns are called “sequences” herein. On 2-min timescales, the method identified epochs of varying arousal or task-engagement, which often lacked stereotyped sequential ordering. These are called “states” herein. Consistent with this nomenclature, the transition matrices of patterns on 15-s timescales were significantly sparser than those on 2-min timescales, indicating they possessed a more stereotypic ordering between behaviors.

In some embodiments, these sequences and states are used to form a hierarchical representation of behavior, which was, again, significantly more structured than expected from Markovian behavior. Rather than being organized as a strict, tree-based hierarchy, behaviors were shared across multiple behavioral sequences, which were then used differentially across behavioral states. For example, grooming of the right forelimb was used both in persistent body grooming sequences and in shorter, more vigorous episodes of grooming, with these sequences being used to different extents in different behavioral states.

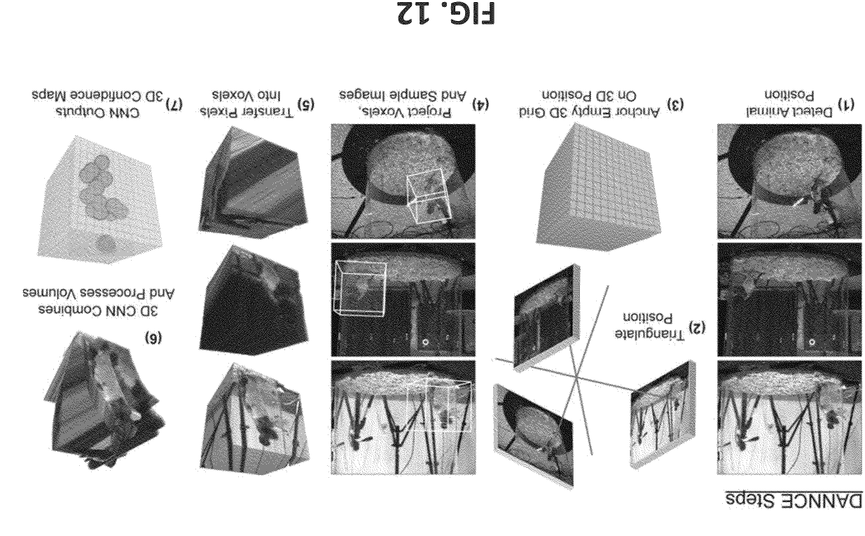

FIG. 10 shows exemplary steps of a process for hierarchically organizing behavior to detect repeated behavioral patterns of a subject, in accordance with some embodiments of the technology described herein. To identify patterns of repeated behaviors, an ethogram (e.g., as obtained from process 900 described in connection with FIG. 9 herein) encapsulating the occurrence of K behaviors over M frames is obtained and smoothed. For example, the ethogram may be smoothed with a boxcar filter across the temporal dimension, using filter windows of τ = 15,120 s. Each frame may then be normalized, yielding a behavioral probability density matrix. In this matrix, individual frames reflect the probability of behavioral usage in a window of length τ. The correlation coefficient between all frames of the density matrix may then be computed, yielding a behavioral similarity matrix of dimensions M × M.

In some embodiments, the process then includes determining off-diagonal elements of the similarity matrix having a value over a threshold value. The off-diagonal elements in this behavioral similarity matrix correspond to pairs of temporal epochs with similar behavioral usage. To identify repeated behavioral patterns, the matrix may be thresholded. For example, regions may be retained if they have a correlation coefficient in their behavioral density vector greater than a threshold value (e.g., 0.3). Thereafter, a watershed transform may be performed on the thresholded similarity matrix, where each region extracted using the watershed transform may correspond to a pair of temporal epochs with similar behavioral usage in the dataset. For single day recordings, this procedure produced 50,000-100,000 epochs of similar behavioral usage to at least one other temporal epoch.

In some embodiments, related behaviors may then be clustered. To detect frequently occurring patterns, the correlation distance between these epochs may be computed, and the resulting distance matrix may be clustered. For example, the resulting distance matrix may be clustered using hierarchical clustering (e.g., with a cutoff of 0.65 and tree depth of 3, for example). The algorithm was linearly sensitive to the clustering cutoff used in a similar manner across animal subjects. A cutoff was selected so that commonly accepted patterns such as the skilled tapping task were identified and not overly split across clusters.

### III. Motion Tracking of Markerless Subjects

The inventors recognized and appreciated that robust tracking of anatomical landmarks in 3D space may be achieved using a trained statistical model. Accordingly, the inventors developed a trained statistical model using a 7-million frame training dataset that relates color video recordings and 3D poses of rodent subjects. In rats and mice, these methods robustly tracked dozens of landmarks on the head, trunk, and limbs of freely moving animals in naturalistic settings, and the methods extended successfully to rat pups, marmosets, and chickadees.

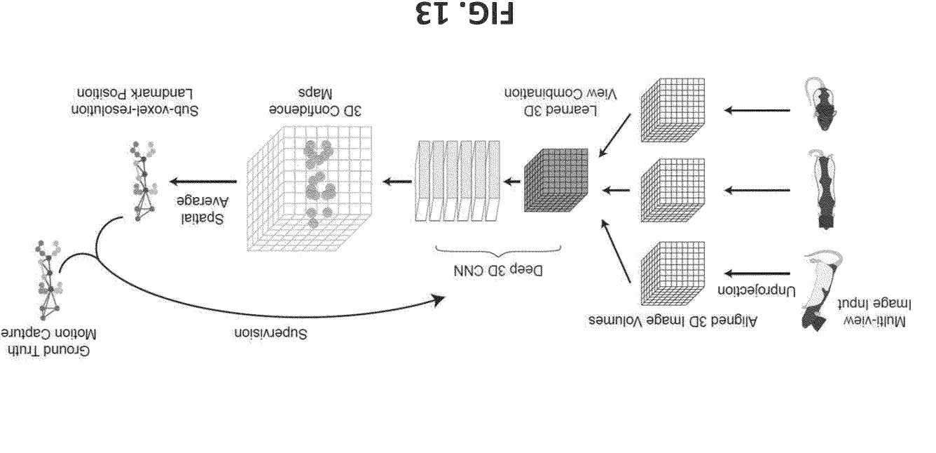

FIG. 11A shows exemplary steps of a process for determining a 3D pose of an animal subject, in accordance with some embodiments of the technology described herein. A video-recording apparatus 1100 includes an enclosure 104 housing a subject 102, and video cameras 1106 are disposed at known locations around the enclosure 104. While the example of FIG. 11A shows only three cameras 1106, it should be understood that additional cameras 1106 (e.g., 6, 12, etc.) may be included, as aspects of this disclosure are not limiting in this respect.

In some embodiments, video frames 1110 are acquired from cameras 1106. For example, video frames 1110 may be obtained in a synchronous manner such that video frames 1110 show different views of the subject 102 at a same time so that the subject’s 3D pose may be extracted from the video frames 1110. In some embodiments, the video frames 1110 may then be provided as input to a landmark detection algorithm configured to determine the 3D animal pose 1112.

In some embodiments, video frames 1110 may be further processed prior to being provided as input to the landmark detection algorithm. For example, projective geometry may be used to process video frames 1110 to generate a 3D projection of the animal subject based on video frames 1110. FIG. 11B shows exemplary steps of a process for constructing a 3D volume from two-dimensional images and determining a 3D pose of an imaged subject, in accordance with some embodiments of the technology described herein. FIG. 12 shows exemplary steps of a process for determining a 3D pose of an imaged subject based on 2D images of the subject, in accordance with some embodiments of the technology described herein.

Then, the animal subject’s position in 3D space may be triangulated based on its position within each video frame. In some embodiments, triangulation may be implemented classically using singular value decomposition to find the least squares solution to a system of equations relating the 3D coordinates of a point to the 2D projected coordinates of the point in images from two different cameras for which the intrinsic and extrinsic parameters are known. Thereafter, a 3D cubic grid large enough to contain the subject may be anchored on a center of mass of the subject. The 3D cubic grid may be discretized into isometric voxels within real 3D space.

In some embodiments, the known camera position and orientation may be used to “unproject” the 2D images of the subject into 3D space, with each voxel in the cubic grid being populated with the set of light rays that intersect it in 3D. In this manner, a 3D volume may be constructed from the data in the individual images using projective geometry, such that each position in the volume is characterized by the RGB values of all 2D pixel values whose traced rays pass through that position. This unprojection provides a set of geometrically aligned 3D spatial features that can be processed by the trained statistical model.

To arrive at this volumetric representation, projective geometry may be used. Starting with a block matrix representation of the extrinsic geometry of each camera,

$${C}^{i} = \left[{R}_{3 \times 3}^{i} \vert {t}_{3 \times 1}^{i}\right] ,$$

where Rⁱ and tⁱ are the global 3D rotation matrix and translation vector of the i^{th} camera, respectively, relative to an anchor coordinate system. The intrinsic geometry of each camera is:

$${K}^{i} = \left[\begin{matrix}{f}_{x}^{i} & 0 & 0 \\ {s}^{i} & {f}_{y}^{i} & 0 \\ {c}_{x}^{i} & {c}_{y}^{i} & 0\end{matrix}\right] ,$$

where

$${f}_{x}^{i}$$

and

$${f}_{y}^{i}$$

are the i^{th} camera’s focal length normalized by the number of pixels along the width and height of the sensor, respectively,

$${c}_{x}^{i}$$

and

$${c}_{y}^{i}$$

are the coordinates of the camera’s principal point, and sⁱ is the sensor’s skew. 3D-to-2D projected, continuous coordinates may then be used to sample from the discrete 2D image with interpolation, transferring the RGB pixel values to voxel positions in a 3D volume. For a single 3D voxel coordinate [x̃, ỹ, z̃]^{T}, its projected 2D coordinates in the original pixel space of camera i are

$${\left[x ′ , y ′\right]}^{\text{T}} = {\left[\frac{u}{z} , \frac{v}{z}\right]}^{\text{T}} ,$$

with

$${\left[u , v , z\right]}^{\text{T}} = {K}^{i} {C}^{i} {\left[\tilde{x} , \tilde{y} , \tilde{z} , 1\right]}^{\text{T}} ,$$

which represents the projective transformation of a 3D world homogeneous coordinate into a point in the camera.

The lens distortion specific to each camera may also be modeled, in some embodiments. From an original 2D point on the image of the i^{th} camera, [x′,y′]^{T}, one may normalize to obtain p̂ = [x̂, ŷ]^{T} = g([x′, y′]^{T}, Kⁱ), representing a normalized point relative to the center of the camera, where g(•, Kⁱ) is a function normalizing points with respect to the camera’s intrinsic parameters. The corrected x- and y-coordinates are then given by

$$p = {\left[x , y\right]}^{\text{T}} = {g}^{- 1} \left({\left[{t}_{x} , {t}_{y}\right]}^{\text{T}} + {\left[{r}_{x} , {r}_{y}\right]}^{\text{T}} , {K}^{i}\right) , \text{and}$$

$${\left[{r}_{x} , {r}_{y}\right]}^{\text{T}} = {\left[\hat{x} , \hat{y}\right]}^{\text{T}} \left(\left[{k}_{1}^{i} , {k}_{2}^{i} , {k}_{3}^{i}\right] ⋅ {\left[{\hat{p}}^{\text{T}} \hat{p} , {\left({\hat{p}}^{\text{T}} \hat{p}\right)}^{2} , {\left({\hat{p}}^{\text{T}} \hat{p}\right)}^{3}\right]}^{\text{T}} + 1\right) , \text{with}$$

$${\left[{t}_{x} , {t}_{y}\right]}^{\text{T}} = \left[\begin{matrix}2 \hat{x} \hat{y} & 2 \hat{x} + {\hat{p}}^{\text{T}} \hat{p} \\ 2 \hat{y} + {\hat{p}}^{\text{T}} \hat{p} & 2 \hat{x} \hat{y}\end{matrix}\right] ⋅ \left[\begin{matrix}{\hat{k}}_{1}^{i} \\ {\hat{k}}_{2}^{i}\end{matrix}\right] ,$$

where

$$\left\{{k}_{1}^{i} , {k}_{2}^{i} , {k}_{3}^{i}\right\} \text{and} \left\{{\hat{k}}_{1}^{i} , {\hat{k}}_{2}^{i}\right\}$$

are the i^{th} camera’s radial and tangential distortion coefficients, respectively. These parameters are fit by a calibration procedure done prior to data collection.

Finally, the 3D volume for view i of an image I at location (x̃, ỹ, z̃) is

$${V}_{\tilde{x} , \tilde{y} , \tilde{z}}^{i} = f \left({I}^{i} , P \left({\left[\tilde{x} , \tilde{y} , \tilde{z}\right]}^{\text{T}} , {C}^{i} {K}^{i}\right)\right) ,$$

where P(•) is the complete 3D-to-2D projective transformation with distortion and ƒ(Iⁱ, [x, y]^{T}) is a function sampling the discrete image Iⁱ at continuous image coordinates (x, y). Note that this implies that

$${V}_{\tilde{x} , \tilde{y} , \tilde{z}}^{i} = f \left({I}^{i} , {\left[x , y\right]}^{\text{T}}\right) ,$$

which reveals that for a ray in the 3D space that projects to the same point in the camera’s pixel space, all values are equivalent. In this way, image features are aligned along epipolar lines through 3D space such that the 3D position of any given point is at the intersection of matched features within this volume.

A statistical model may be trained using ground-truth 3D labels to fuse features across cameras and estimate a confidence map over voxels for each landmark. FIG. 13 show exemplary steps of training a statistical model to determine a 3D pose of an imaged subject, in accordance with some embodiments of the technology described herein. The trained statistical model may generate a confidence map describing a likely location of positions of each landmark within the voxel grid. A spatial average may be taken to determine the estimated 3D pose of the animal subject. The estimated 3D pose of the animal subject may then be compared to a ground truth 3D pose as obtained from motion capture tracking.

In some embodiments, the training data set may encompass a total of 10.8 hours across 6 different rat subjects and 30 camera views. This “Rat 7 M” dataset contains 6,986,058 frames and a wide diversity of rat behaviors. These recordings may be subdivided into 12 high-level categories using a behavioral embedding and clustering approach based on kinematic marker features (e.g., as described herein). This allows training examples to be balanced over poses and establishes standardized categories for benchmarking.

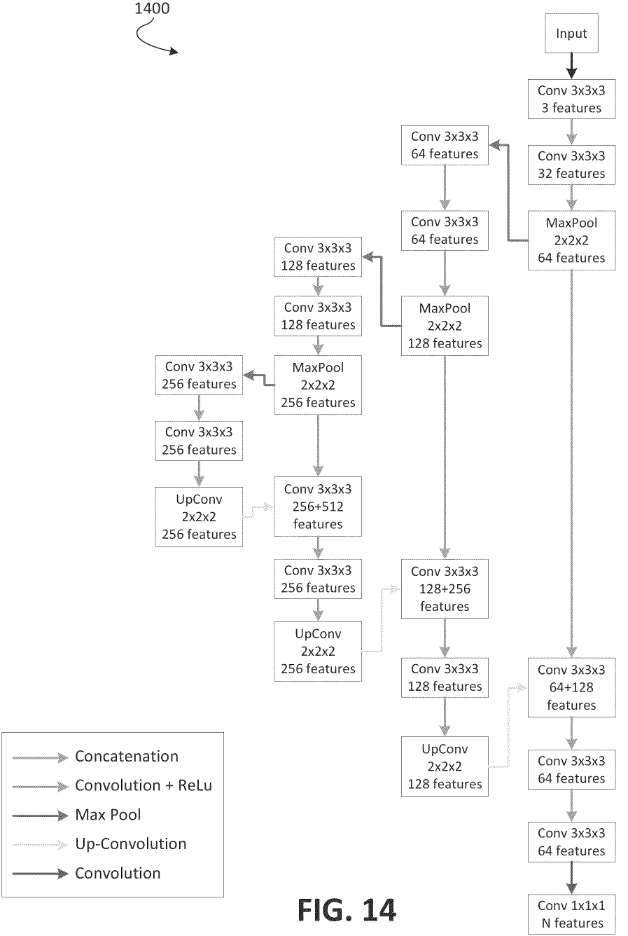

In some embodiments, the trained statistical model may comprise a neural network. For example, the neural network may comprise one or more convolutional layers (e.g., 3D convolutional layers. In some embodiments, the one or more convolutional layers may be arranged as a U-net, as shown in the example of FIG. 14, which shows an exemplary architecture of neural network 1400 that may be used to determine a 3D pose of a subject.

Neural network 1400 is arranged as a 3D U-net, in which multiple convolutional layers downsample the data and subsequent transpose convolutional layers upsample the data. This architecture is designed to harness both local and global image content via skip connections. Thus, decisions about landmark location can include both local features like color and shape and also higher-level information about the relationships between landmarks across the entire body of the animal.

In some embodiments, the trained statistical model may be implemented in Tensorflow and Keras and trained using the Adam optimizer (e.g., learning rate = 0.001, β₁ = 0.9, β₂ = 0.999) for 30 epochs with a batch size of 4. Neural network 1400 includes an analysis path and a synthesis path, each with four resolution steps. In the analysis path, each layer contains two 3 × 3 ×3 convolutions each followed by a rectified linear unit (ReLu) and then a 2 × 2 × 2 max pooling with strides of two in each dimension. In the synthesis path, each layer includes an upconvolution of 2 × 2 × 2 by strides of two in each dimension, followed by two 3 × 3 × 3 convolutions each followed by a ReLu. Shortcut connections from layers of equal resolution in the analysis path provide high-resolution features to the synthesis path. In the last layer, a 1 × 1 × 1 convolution reduces the number of output channels to the number of labels. The following number of features were used in each layer: [64, 64, 128, 128, 256, 256, 512, 512, 256, 256, 128, 128, 64, 64, N (the number of landmarks)]. A Glorot uniform initialization was used for all weights. Additional aspects of a U-net architecture are described by “Volumetric Segmentation with the 3D U-Net” by Özgün Cicek, et al., published on the ArXiv on Jun. 21, 2016 (arXiv:1606.06650v1), which is incorporated herein by reference in its entirety.

In some embodiments, the network learns to fuse information across views using aligned local image structure, including depth cues in the form of ray tracing convergence patterns. This is achieved by concatenating the input volumes along the color axis, such that

$${V}_{n} = \left[{V}_{n}^{1} , … , {V}_{n}^{j}\right]$$

for j total views and feeding the concatenation as input into the trained statistical model. To promote view invariance and to remove any dependence on camera order, the camera order was shuffled in each training example, although for applications with more static camera arrangements, this constraint can be lifted to better leverage view idiosyncrasies.

To ensure that tracked landmarks can be discovered anywhere in an image as long as they present with similar features across multiple scales, the problem may be treated as pixel-wise semantic segmentation, rather than coordinate regression, in some embodiments. This may also reduce the amount of required training data. Such supervision could be applied directly to 3D voxels, but doing so would pin our resolution to a coarse grid. Instead, the trained statistical model outputs an intermediate probability distribution map over 3D space for each marker, Gₘ, and applies a spatial softmax such that Σ_{x,y},_{z} Gₘ = 1. Then, sub-voxel resolution coordinates may be produced for the mth landmark by taking the spatial expected value:

$$\begin{matrix}\left[{x}_{m} , {y}_{m} , {z}_{m}\right] = {\sum }_{x , y , z} \left[x ⋅ {G}_{m} \left(x , y , z\right) , y ⋅ {G}_{m} \left(x , y , z\right) ,\right) \\ \left(z ⋅ {G}_{m} \left(x , y , z\right)\right] .\end{matrix}$$

The trained statistical model may then be trained using an L2 loss. This version of the network is called “AVG,” for the spatial average applied to produce the output. In some embodiments, supervising the 3D output distributions directly using 3D spherical Gaussians converged to a lower error on the training set. This version of the network is called “MAX,” as landmark positions are assigned to the voxels containing the maximum value of the 3D output distributions. In this manner, the trained statistical model learns to infer landmark positions from ray intersections in a 3D feature space formed from combined image content across multiple views. This feature space is metric, i.e. in units of physical coordinates rather than camera pixels, allowing the network to leverage learned spatial statistics of the body to resolve feature ambiguities and make landmark inferences even in the presence of occlusions.

To compare the 3D trained statistical model approach described herein with post hoc triangulation used by DeepLabCut, both methods were trained on the same set of video frames and poses (180,456 unique frames, 3,609,120 markers) and tested on new camera views in a subject withheld from training. Qualitative visualizations showed that the 3D trained statistical model generalized immediately, while DeepLabCut struggled to track the same landmarks. To quantify this, the error and accuracy of landmark predictions relative to ground truth motion capture was computed. The published DeepLabCut triangulation protocol was sensitive to 2D-tracking outliers. In both 3- and 6-camera comparisons, the 3D trained statistical model showed over 30-fold lower error and over 3-fold greater accuracy. While DeepLabCut predictions improved when a modified triangulation protocol was used that discounted outliers, the 3D trained statistical model continued to outperform DeepLabCut. Using 3 cameras, the 3D trained statistical model had nearly 4-fold lower error, over 10-fold lower uncertainty, and over 2-fold greater accuracy (the 3D trained statistical model: 13.1 ± 9.0 mm, 10.7 mm median error, 79.5% accuracy; DeepLabCut 51.6 ± 100.8 mm, 28.1 mm, 31.3%. Indeed, the 3D trained statistical model with only 3 cameras outperformed DeepLabCut with 6 cameras. Comparing the fraction of frames with a fully reconstructed pose, the 3D trained statistical model also outperformed DeepLabCut by 26-and 5-fold for 3 and 6 cameras, respectively. The 3D trained statistical model tracked all marker types better than DeepLabCut and showed higher accuracy and lower error across all behaviors. The 3D trained statistical model’s error was also more stable over time, providing the temporal consistency required for extracting higher-order kinematic quantities. Some, but not all, periods of correlated 3D trained statistical model- and DeepLabCut-error increases occurred during contorted grooming behaviors.

The lower performance of DeepLabCut was not due to technical issues with the training procedure. A control evaluation of DeepLabCut on animals in the training set (e.g., after DeepLabCut had been trained with 180,456 frames from the tracked animal subjects) showed better performance than on animal subjects for which training data was withheld. This indicates that DeepLabCut does not develop a generalizable 3D geometric understanding applicable to unknown subjects or situations.

As a further test of the 3D trained statistical model’s ability to reason geometrically, its performance was evaluated on input volumes constructed from a single camera view. Here, 3D marker positions are estimated from learned spatial priors and nuanced patterns of ray convergence. The single-camera 3D trained statistical model version outperformed DeepLabCut with 2 cameras (3D trained statistical model: 15.6 mm error; DeepLabCut: 123.2 mm), because the 3D trained statistical model uses learned 3D representations to interpolate when critical information is missing. The 3D trained statistical model can also correct small errors in camera calibration and withstand decreases in image resolution.

To estimate the performance on rat subjects in other labs, where a small sample of hand-labeled data could be used to tailor the network to new subjects, the 3D trained statistical model was tested after training with additional data. First, the training set was expanded to include a fifth animal and observed that the 3D trained statistical model’s performance increased slightly on the held-out validation subject (median error 7.8 mm, 92.3% accuracy). This expanded 3D trained statistical model was then fine-tuned using a small set of within-subject ground truth data. The 3D trained statistical model’s error dropped substantially (median error 3.5 mm, 95.1% accuracy), below even a 3D voxel side length (3.75 mm). The 3D trained statistical model also generalized to new behaviors not in the training set, a condition likely to be encountered in future experimental manipulations.

The 3D trained statistical model’s substantial performance improvements in generalization were not restricted to rats bearing markers. The 3D trained statistical model and DeepLabCut networks were applied to markerless rats and mice, the latter after fine-tuning the 3D trained statistical model and DeepLabCut with 50 timepoints of hand-labeled data. Qualitatively, the 3D trained statistical model generalized, whereas DeepLabCut struggled to track most landmarks, often making large errors on individual landmarks and collapsing the left and right sides of the body into a single plane.

In rats, the error of the 6-camera 3D trained statistical model predictions relative to hand-labeled points (8.4 ± 4.6 mm) was close to the error between the human labelers themselves (8.0 ± 4.8 mm), whereas the 6-camera DeepLabCut error (24.8 ± 37.2 mm) was higher and more variable. This performance gap was exacerbated when using just 3 cameras (the 3D trained statistical model: 9.4 ± 5.9 mm; DeepLabCut: 58.0 ± 92.3 mm) and was especially prominent for the head (the 3D trained statistical model: mean error: 6.5 mm, 7.7; DeepLabCut: 39.3, 81.9 for 6-camera and 3-camera, respectively). The 3D trained statistical model’s reconstruction accuracy was also better than DeepLabCut’s reconstruction accuracy, especially at small error thresholds; and the 3D trained statistical model showed 33-and 4-fold increases over DeepLabCut in the fraction of timepoints with the full pose accurately reconstructed for 3 and 6 cameras, respectively. In addition, whereas the 3D trained statistical model could infer the locations of a full set of landmarks with high reconstruction accuracy, human labeler accuracy dropped when labeling more than about 15 landmarks. In validation mouse datasets, the 3D trained statistical model showed approximately 5-fold lower error and 2-fold higher accuracy than DeepLabCut (the 3D trained statistical model error: 3.9 ± 6.2 mm, DeepLabCut: 17.6 ± 23.0 mm; the 3D trained statistical model accuracy; 94.2%, DeepLabCut: 38.5%. The 3D trained statistical model performance improved further, surpassing that of humans, when using additional cameras (5-camera 3D trained statistical model 97.2% accuracy, inter-human: 94.8%).

Rodents are model systems for investigating the neural basis of behavior. However, precise measurements of 3D kinematics and behavioral type have thus far been limited to constrained environments and a limited subset of behaviors. To test whether the 3D trained statistical model could provide detailed 3D kinematics across a wide range of behaviors, unsupervised behavioral maps were first created from 3D trained statistical model recordings. In rats, maps were qualitatively similar to those obtained from animal subjects with markers, with human annotators confirming that all coarse Rat 7 M behavioral categories were recovered. In mice, behavioral maps isolated common behaviors, such as rearing and walking, and rarer behaviors that have been difficult to differentiate in the past, such as face, body, and tail grooming. The set of identified behaviors was larger than what has been mapped using 2D pose tracking techniques.

The 3D trained statistical model’s ability to report the 3D kinematics of unconstrained behaviors and reveal previously inaccessible characteristics of 3D body coordination was then assessed. As a validation, the kinematics of walking behaviors were characterized. In agreement with past studies in constrained settings (treadmill), walking was found to comprise ~3 Hz oscillations in the limbs and tail that were strongest in horizontal (x and y) velocity components. This frequency peak was absent in the head and trunk, suggesting that mice, like humans, stabilize their posture and gaze during locomotion. Grooming behaviors were next characterized, whose kinematic properties remain unknown, hence limiting phenotyping precision. Facial grooming was characterized by 5 Hz oscillations of the forelimbs and head and, to a lesser extent, the trunk. Similarly, left and right forelimb grooming disproportionally engaged their respective side-specific forelimbs at 5 Hz, suggesting reuse of a common pattern generator across these behaviors.

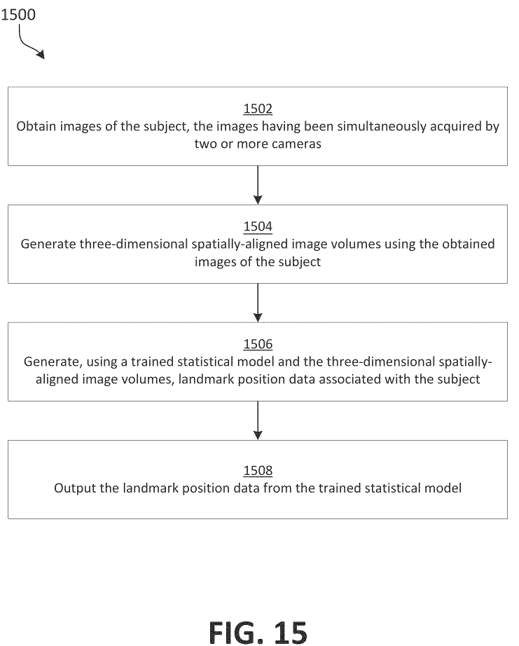

FIG. 15 is a flowchart illustrating a process 1500 of determining a three-dimensional pose of an imaged subject, in accordance with some embodiments of the technology described herein. Process 1500 may be executed using any suitable computing device (e.g., computing device 1700 as described herein). For example, in some embodiments, process 1500 may be performed by a computing device co-located (e.g., in the same room) with a motion capture and/or video recording apparatus (e.g., apparatuses 100, 200, and/or 1100) that obtained the information indicative of motion by recording a subject. As another example, in some embodiments, process 1500 may be performed by one or more processors located remotely from the motion capture and/or video recording apparatus (e.g., as part of a cloud computing environment, as part of a remote network) that obtained the information indicative of motion by recording the subject.

In some embodiments, the process 1500 begins at act 1502. In act 1502, images of the subject are obtained. The images of the subject that are obtained have been simultaneously acquired by two or more cameras. The two or more cameras may be positioned around the subject at different, known locations. For example, the images of the subject may have been obtained by two or more video cameras positioned at different locations and simultaneously recording video frames including images of the subject.

In some embodiments, obtaining images of the subject comprises accessing the images of the subject. For example, the images of the subject may have been previously recorded by a recording apparatus (e.g., a video recording apparatus 1100) and stored for subsequent analysis, so that it is accessed at act 1502. In other embodiments, the images of the subject may be obtained by a video recording apparatus as part of process 1500.

After act 1502, process 1500 may proceed to act 1504, where 3D spatially-aligned image volumes are generated using the obtained images of the subject (e.g., as described in connection with FIGS. 11B and 12 herein). Generating the 3D spatially-aligned image volumes may comprise first determining a 3D position of the subject by triangulating the subject’s 3D position based on the obtained images. Thereafter, a 3D grid including voxels may be centered around the subject’s 3D position, and spatial coordinates of the voxels may be projected to the 2D space of the images based on known or calibrated positions of the two or more cameras. Thereafter, the 3D spatially-aligned image volumes may be generated by projecting RGB image content of the 2D images at each 2D voxel location to the voxel’s 3D position.

After act 1504, process 1500 may proceed to act 1506. At act 1506, landmark position data associated with the subject may be generated using a trained statistical model and the 3D spatially-aligned image volumes. The landmark position data may indicate positions of landmarks (e.g., joints, extremities, limb positions, skeletal positions, etc.) on the subject’s body within 3D space. For example, the trained statistical model may take the 3D spatially-aligned image volumes as input and then generate the landmark position data based on the 3D spatially-aligned image volumes. In some embodiments, generating the landmark position data comprises generating 3D confidence maps describing a probability of a landmark’s position.

In some embodiments, the trained statistical model may be a neural network. For example, the neural network may include one or more convolutional layers. The one or more convolutional layers may be arranged as a U-net, in some embodiments. An example of a suitable neural network architecture is described in connection with FIG. 14 and neural network 1400 herein.

After act 1506, the process may proceed to act 1508, where the landmark position data is output from the trained statistical model. For example, the landmark position data may be saved on computer memory for subsequent access, transmitted to a recipient over a network, displayed, and/or printed.

In some embodiments, where generating the landmark position data comprises generating 3D confidence maps describing a probability of a landmark’s position, the method further comprises determining a 3D pose of the subject using the output landmark position data. For example, determining the 3D pose of the subject may comprise performing a spatial average of the landmark position data to generate landmark positions describing the 3D pose of the subject.

In some embodiments, process 1500 also includes determining the 3D pose of the subject over a period of time. For example, the images of the subject may comprise video frames acquired synchronously by two or more cameras over a period of time. In such embodiments, process 1500 may be used to determine the 3D pose of the subject for each set of video frames acquired at a same point in time.

In some embodiments, process 1500 also includes generating a behavioral profile of the subject based on the determined 3D poses of the subject over a period of time. In some embodiments, the process 900 described in connection with FIG. 9 may be used to generate the behavioral profile of the subject. For example, process 1500 may include obtaining, using the 3D pose of the subject over the period of time, information indicative of movement of the subject over the period of time (e.g., kinematic information). Process 1500 may then include clustering instances of one or more physical behaviors based at least in part on the information indicative of movement, generating a profile of the subject’s physical behavior over the period of time based on the clustered instances of the one or more physical behaviors, and outputting the profile of the subject’s physical behavior.

In some embodiments, process 1500 also includes comprises identifying repeated behavioral sequences of the subject. In some embodiments, the process described in connection with FIG. 10 may be used to identify the repeated behavioral sequences of the subject. For example, process 1500 may include obtaining a similarity matrix by computing pairwise correlations using the profile of the subject’s physical behavior. Thereafter, process 1500 may include determining off-diagonal elements of the similarity matrix having a value over a threshold value, the off-diagonal elements corresponding to related behaviors of the subject. Finally, process 1500 may include clustering the related behaviors of the subject to identify repeated behavioral sequences of the subject.

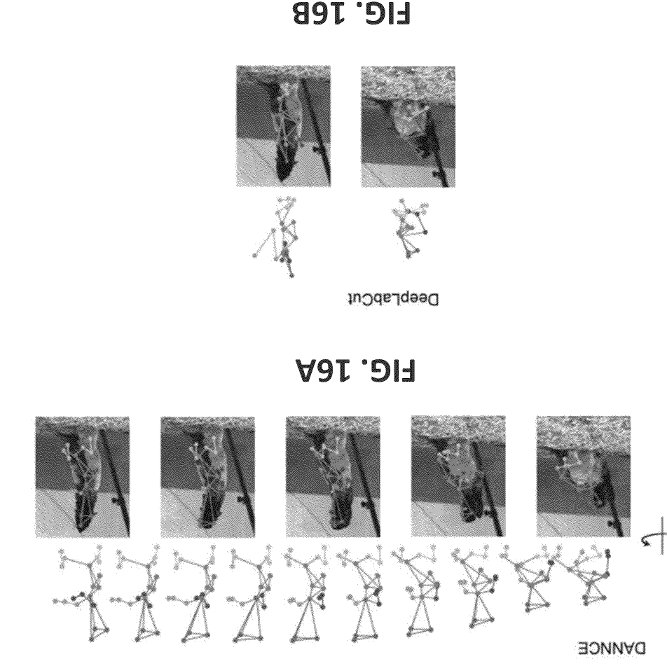

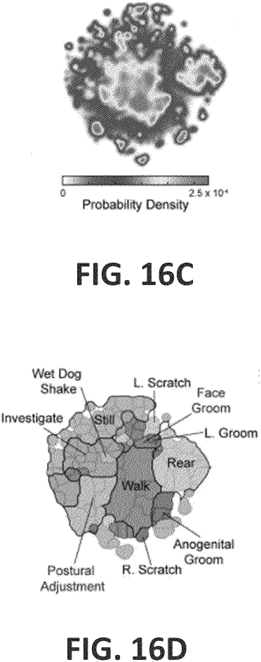

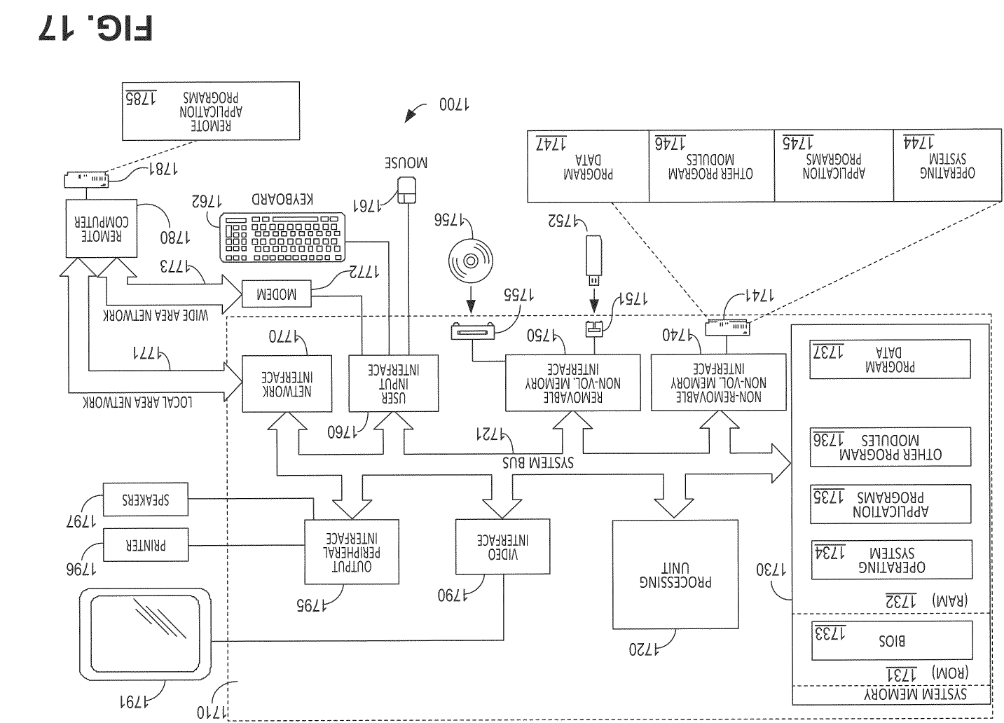

FIG. 16A shows exemplary 3D wireframe models corresponding to a pose of a markerless subject, the 3D wireframe models being determined using a trained statistical model, in accordance with some embodiments of the technology described herein. The 3D wireframe models (top) were predicted for a rearing sequence in a markerless rat, with input provided from 6 total cameras. The bottom images shows every other frame of the top row projected onto a single 2D camera view. In comparison, FIG. 16B shows 3D wireframe models corresponding to a pose of a markerless subject, the 3D wireframe models being determined using DeepLabCut. The 3D wireframe models (top) do not match the subject’s pose in the corresponding 2D camera view (bottom).

FIG. 16C shows a density map of behavioral space determined based on recordings of three markerless rat subjects, in accordance with some embodiments of the technology described herein. The density map of behavioral space was isolated from approximately 3.5 hours of recording of the markerless rats. FIG. 16D shows the density map of FIG. 16C with overlaid behavioral clusters outlined, in accordance with some embodiments of the technology described herein. The clustered map of FIG. 16D was segmented into low-level clusters (light outlines) and high-level clusters (dark outlines) using watershed segmentation. Both FIGS. 16C and 16D were obtained using the behavioral clustering methods described herein (e.g., as described in connection with FIG. 9 herein).

To trace evolutionary relationships and, more generally, to extend 3D tracking to other species and taxa, would require the methods described herein, trained on rats, to extend to animals with different body shapes and behavioral repertoires. To test this, the methods described herein were first applied to the marmoset. Three cameras were used to record freely moving marmoset behavior in an enriched homecage containing multiple occlusions and distractors, such as perches and balls. Marmoset behavior was accurately tracked despite the presence of substantial occlusions, and skeletal segment lengths and landmark position were estimated with accuracy near that of human labelers, with errors well below a body segment length. Behavioral maps revealed 9 high-level behavioral categories, including jumping, perching, clinging, cage gripping, and object interaction.

To demonstrate extensibility beyond mammals, the methods used herein were also used to track black-capped chickadees engaged in a foraging and caching task in a complex environment. Despite the substantial differences between rats and chickadees in body shape and behavioral repertoire, the methods described herein were able to provide accurate predictions across all landmarks with precision commensurate with human labelers and errors well below body segment lengths. Analyzing the data revealed diverse locomotor, preening, gaze, and pecking behaviors, providing clues to how a complex foraging behavior is built from behavioral modules.

The above-described embodiments of the technology described herein can be implemented in any of numerous ways. For example, the embodiments may be implemented using hardware, software or a combination thereof. When implemented in software, the software code can be executed on any suitable processor or collection of processors, whether provided in a single computing device or distributed among multiple computing devices. Such processors may be implemented as integrated circuits, with one or more processors in an integrated circuit component, including commercially available integrated circuit components known in the art by names such as CPU chips, GPU chips, microprocessor, microcontroller, or co-processor. Alternatively, a processor may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor may be implemented using circuitry in any suitable format.

Further, it should be appreciated that a computing device may be embodied in any of a number of forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone, tablet, or any other suitable portable or fixed electronic device.

Also, a computing device may have one or more input and output devices. These devices can be used, among other things, to present a user interface. Examples of output devices that can be used to provide a user interface include display screens for visual presentation of output and speakers or other sound generating devices for audible presentation of output. Examples of input devices that can be used for a user interface include keyboards, individual buttons, and pointing devices, such as mice, touch pads, and digitizing tablets. As another example, a computing device may receive input information through speech recognition or in other audible format.

Such computing devices may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the embodiments described herein may be embodied as a computer readable storage medium (or multiple computer readable media) (e.g., a computer memory, one or more floppy discs, compact discs (CD), optical discs, digital video disks (DVD), magnetic tapes, flash memories, RAM, ROM, EEPROM, circuit configurations in Field Programmable Gate Arrays or other semiconductor devices, or other tangible computer storage medium) encoded with one or more programs that, when executed on one or more computers or other processors, perform methods that implement the various embodiments discussed above. As is apparent from the foregoing examples, a computer readable storage medium may retain information for a sufficient time to provide computer-executable instructions in a non-transitory form. Such a computer readable storage medium or media can be transportable, such that the program or programs stored thereon can be loaded onto one or more different computing devices or other processors to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of this embodiment, one or more computer programs that when executed perform methods of the present disclosure need not reside on a single computing device or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

The embodiments described herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Further, some actions are described as taken by a “user.” It should be appreciated that a “user” need not be a single individual, and that in some embodiments, actions attributable to a “user” may be performed by a team of individuals and/or an individual in combination with computer-assisted tools or other mechanisms.

With reference to FIG. 17, an exemplary system for implementing aspects of the invention includes a general purpose computing device in the form of a computer 1710. Components of computer 1710 may include, but are not limited to, a processing unit 1720, a system memory 1730, and a system bus 1721 that couples various system components including the system memory to the processing unit 1720. The system bus 1721 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 1710 typically includes a variety of computer readable media. Computer readable media can be any available media that can be accessed by computer 1710 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 1710. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 1730 includes computer storage media in the form of volatile and/or nonvolatile memory such as read only memory (ROM) 1731 and random access memory (RAM) 1732. A basic input/output system 1733 (BIOS), containing the basic routines that help to transfer information between elements within computer 1710, such as during start-up, is typically stored in ROM 1731. RAM 1732 typically contains data and/or program modules that are immediately accessible to and/or presently being operated on by processing unit 1720. By way of example, and not limitation, FIG. 17 illustrates operating system 1734, application programs 1735, other program modules 1736, and program data 1737.

The computer 1710 may also include other removable/non-removable, volatile/nonvolatile computer storage media. By way of example only, FIG. 10 illustrates a hard disk drive 1741 that reads from or writes to non-removable, nonvolatile magnetic media, a magnetic disk drive 1751 that reads from or writes to a removable, nonvolatile magnetic disk 1752, and an optical disk drive 1755 that reads from or writes to a removable, nonvolatile optical disk 1756 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1741 is typically connected to the system bus 1721 through an non-removable memory interface such as interface 1740, and magnetic disk drive 1751 and optical disk drive 1755 are typically connected to the system bus 1721 by a removable memory interface, such as interface 1750.

The drives and their associated computer storage media discussed above and illustrated in FIG. 17, provide storage of computer readable instructions, data structures, program modules and other data for the computer 1710. In FIG. 17, for example, hard disk drive 1741 is illustrated as storing operating system 1744, application programs 1745, other program modules 1746, and program data 1747. Note that these components can either be the same as or different from operating system 1734, application programs 1735, other program modules 1736, and program data 1737. Operating system 1744, application programs 1745, other program modules 1746, and program data 1747 are given different numbers here to illustrate that, at a minimum, they are different copies. A user may enter commands and information into the computer 1710 through input devices such as a keyboard 1762 and pointing device 1761, commonly referred to as a mouse, trackball or touch pad. Other input devices (not shown) may include a microphone, joystick, game pad, satellite dish, scanner, or the like. These and other input devices are often connected to the processing unit 1720 through a user input interface 1760 that is coupled to the system bus, but may be connected by other interface and bus structures, such as a parallel port, game port or a universal serial bus (USB). A monitor 1791 or other type of display device is also connected to the system bus 1721 via an interface, such as a video interface 1790. In addition to the monitor, computers may also include other peripheral output devices such as speakers 1797 and printer 1796, which may be connected through a output peripheral interface 1795.

The computer 1710 may operate in a networked environment using logical connections to one or more remote computers, such as a remote computer 1780. The remote computer 1780 may be a personal computer, a server, a router, a network PC, a peer device or other common network node, and typically includes many or all of the elements described above relative to the computer 1710, although only a memory storage device 1781 has been illustrated in FIG. 17. The logical connections depicted in FIG. 17 include a local area network (LAN) 1771 and a wide area network (WAN) 1773 but may also include other networks. Such networking environments are commonplace in offices, enterprise-wide computer networks, intranets and the Internet.

When used in a LAN networking environment, the computer 1710 is connected to the LAN 1771 through a network interface or adapter 1770. When used in a WAN networking environment, the computer 1710 typically includes a modem 1772 or other means for establishing communications over the WAN 1773, such as the Internet. The modem 1772, which may be internal or external, may be connected to the system bus 1721 via the user input interface 1760, or other appropriate mechanism. In a networked environment, program modules depicted relative to the computer 1710, or portions thereof, may be stored in the remote memory storage device. By way of example, and not limitation, FIG. 10 illustrates remote application programs 1785 as residing on memory device 1781. It will be appreciated that the network connections shown are exemplary and other means of establishing a communications link between the computers may be used.

The various methods or processes outlined herein may be implemented in any suitable hardware. Additionally, the various methods or processes outlined herein may be implemented in a combination of hardware and of software executable on one or more processors that employ any one of a variety of operating systems or platforms. For example, the various methods or processes may utilize software to instruct a processor to activate one or more actuators to perform motions such as those described herein, such as motion of one or more regions of a container and/or of a build platform. Examples of such approaches are described above. However, any suitable combination of hardware and software may be employed to realize any of the embodiments discussed herein.

In this respect, various inventive concepts may be embodied as at least one non-transitory computer readable storage medium (e.g., a computer memory, one or more floppy discs, compact discs, optical discs, magnetic tapes, flash memories, circuit configurations in Field Programmable Gate Arrays or other semiconductor devices, etc.) encoded with one or more programs that, when executed on one or more computers or other processors, implement the various embodiments of the present invention. The non-transitory computer-readable medium or media may be transportable, such that the program or programs stored thereon may be loaded onto any computer resource to implement various aspects of the present invention as discussed above.

The terms “program” or “software” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present invention need not reside on a single computer or processor but may be distributed in a modular fashion among different computers or processors to implement various aspects of the present invention.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Various inventive concepts may be embodied as one or more methods, of which examples have been provided. For example, systems and methods for generating and using trained statistical models have been provided herein. The acts performed as part of any method described herein may be ordered in any suitable way. Accordingly, embodiments may be constructed in which acts are performed in an order different than illustrated, which may include performing some acts simultaneously, even though these acts may have been shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein, unless clearly indicated to the contrary, should be understood to mean “at least one.”

As used herein, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

The phrase “and/or,” as used herein, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with openended language such as “comprising” can refer, in one embodiment, to A only (optionally including elements other than B); in another embodiment, to B only (optionally including elements other than A); in yet another embodiment, to both A and B (optionally including other elements); etc.

As used herein, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.”

The phraseology and terminology used herein is for the purpose of description and should not be regarded as limiting. The use of “including,” “comprising,” “having,” “containing”, “involving”, and variations thereof, is meant to encompass the items listed thereafter and additional items.

While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art. Accordingly, the foregoing description and drawings are by way of example only.

What is claimed is:

1. A method for profiling a subject’s physical behavior over a period of time, the method comprising:
obtaining information indicative of movement of one or more portions of the subject over the period of time;
clustering instances of one or more physical behaviors based at least in part on the information indicative of movement;
generating a profile of the subject’s physical behavior over the period of time based on the clustered instances of the one or more physical behaviors; and
outputting the profile of the subject’s physical behavior.

2. The method of claim 1, further comprising:
applying a transform to the information indicative of movement to obtain a wavelet representation of the subject’s physical behavior over the period of time; and
embedding the wavelet representation into two dimensions to obtain an embedded representation of the subject’s physical behavior over the period of time,
wherein clustering instances of the one or more physical behaviors based at least in part on the information indicative of movement comprises clustering instances of the one or more physical behaviors based on the embedded representation.

3. The method of claim 1, wherein obtaining information indicative of movement of one or more portions of the subject comprises obtaining information indicative of movement of one or more limbs, joints, and/or a torso of the subject.

4. The method of claim 2, wherein obtaining the information indicative of movement comprises:
obtaining a plurality of video frames, wherein video frames of the plurality of video frames recorded the subject’s physical behavior over a period of time, the video frames having been synchronously acquired by two or more cameras at different positions; and
extracting, from the plurality of video frames, the information indicative of movement.

5. The method of claim 4, further comprising affixing markers to the subject’s body.

6. The method of claim 5, wherein affixing markers to the subject’s body comprises piercing the subject’s body with a marker.

7. The method of claim 5, wherein extracting, from the plurality of video frames, the information indicative of movement comprises extracting, from the plurality of video frames, information indicative of movement of the markers affixed to the subject’s body.

8. The method of claim 1, further comprising smoothing, using a filter, the information indicative of movement.

9. The method of claim 1, wherein generating a profile of the subject’s physical behavior comprises generating an ethogram.

10. The method of claim 9, further comprising identifying repeated behavioral sequences of the subject by:
obtaining a similarity matrix by computing pairwise correlations using the ethogram;
determining off-diagonal elements of the similarity matrix having a value over a threshold value, the off-diagonal elements corresponding to related behaviors of the subject; and
clustering the related behaviors of the subject to identify repeated behavioral sequences of the subject.

11. A non-transitory computer readable storage medium including instructions that when executed by one or more processors perform the method of claim 1.

12. A method for determining a three-dimensional pose of an imaged subject, the method comprising:
obtaining images of the subject, the images having been simultaneously acquired by two or more cameras;
generating three-dimensional spatially-aligned image volumes using the obtained images of the subject;
generating, using a trained statistical model and the three-dimensional spatially-aligned image volumes, landmark position data associated with the subject; and
outputting the landmark position data from the trained statistical model.

13. The method of claim 12, wherein generating the three-dimensional, spatially-aligned image volumes comprises:
determining a three-dimensional position of the subject using triangulation and the obtained images;
centering a three-dimensional grid comprising voxels around the determined three-dimensional position of the subject;
projecting spatial coordinates of the voxels to two-dimensional space of the images based on known positions of the two or more cameras; and
generating the three-dimensional, spatially-aligned image volumes by projecting RGB image content of the images at each two-dimensional voxel location to the voxel’s three-dimensional position.

14. The method of claim 12, wherein the trained statistical model comprises a neural network.

15. The method of claim 14, wherein the neural network comprises one or more convolutional layers.

16. The method of claim 15, wherein the one or more convolutional layers are arranged as a U-net.

17. The method of claim 12, wherein generating the landmark position data comprises averaging three-dimensional confidence maps generated by the trained statistical model.

18. The method of claim 12, further comprising determining a three-dimensional pose of the subject using the output landmark position data.

19. The method of claim 18, wherein the images comprise video frames acquired synchronously by the two or more cameras over a period of time, and
determining the three-dimensional pose of the subject comprises determining the three-dimensional pose of the subject over the period of time.

20. The method of claim 19, further comprising:
obtaining, using the three-dimensional pose of the subject over the period of time, information indicative of movement of the subject over the period of time;
clustering instances of one or more physical behaviors based at least in part on the information indicative of movement;
generating a profile of the subject’s physical behavior over the period of time based on the clustered instances of the one or more physical behaviors; and
outputting the profile of the subject’s physical behavior.

21. The method of claim 20, further comprising identifying repeated behavioral sequences of the subject by:
obtaining a similarity matrix by computing pairwise correlations using the profile of the subject’s physical behavior;
determining off-diagonal elements of the similarity matrix having a value over a threshold value, the off-diagonal elements corresponding to related behaviors of the subject; and
clustering the related behaviors of the subject to identify repeated behavioral sequences of the subject.

22. The method of claim 12, wherein obtaining images of the subject comprises obtaining images of an animal.

23. A non-transitory computer readable storage medium including instructions that when executed by one or more processors perform the method of claim 12.

24. A motion capture marker comprising:
a tissue engaging feature; and
a reflective marker attached to the tissue engaging feature, the reflective marker comprising a ball lens having an index of refraction in a range from 1.25 to 3.

25. The motion capture marker of claim 24, wherein the tissue engaging feature comprises a dermal or a transdermal piercing.

26. The motion capture marker of claim 24, wherein the ball lens comprises a half-silvered mirror.
